(19) United States
(12) Patent Application Publication
(10) Pub. No.: US 2023/0377154 A1
(43) Pub. Date: Nov. 23, 2023

(54) SYSTEMS AND METHODS FOR MULTI-STAGE QUALITY CONTROL OF DIGITAL MICROGRAPHS

(71) Applicant: HistoWiz, Inc., Brooklyn, NY (US)

(72) Inventors: Ke CHENG, Brooklyn, NY (US); Matthew WILDER, Boulder, CO (US)

(21) Appl. No.: 18/230,570

(22) Filed: Aug. 4, 2023

Related U.S. Application Data
(63) Continuation of application No. PCT/US2022/039568, filed on Aug. 5, 2022.
(60) Provisional application No. 63/230,475, filed on Aug. 6, 2021.

(51) Int. Cl. G06T 7/00

(52) U.S. Cl. CPC G06T 7/0014; G06T 2207/30004; G06T 2207/30168; G06T 2207/20084; G06T 2207/20081; G06T 2207/10064; G06T 2207/10056

(57) ABSTRACT

Provided herein are methods and systems for performing an automated quality control analysis of digital micrographs representing slides with tissue samples. An automated quality control analysis may comprise analyzing digital micrographs of histology slides for gross errors and excessive regions of blurriness.

### CROSS-REFERENCE

This application is a continuation of International Application Number PCT/US2022/039568, filed Aug. 5, 2022, which claims the benefit of U.S. Provisional Application No. 63/230,475 filed on Aug. 6, 2021, which applications are incorporated herein by reference in their entirety.

### BACKGROUND

Histology is the study of microscopic structures of tissues. Typically, histology slides are formed from thin sections tissue samples which have been cut from a block. The block may contain the tissue sample within an embedding medium. Cuts from the block may be placed onto a slide for examination under a microscope. This slide may be referred to as a histology slide. The tissue samples are often stained such that features and cells are distinguishable. Digital histology slides may be formed from scanning images of histology slides. The digital images of the histology slides may then be analyzed to perform a histopathologic analysis of the tissue samples. Computer systems may facilitate sharing and analysis of digital micrographs representing histology slides.

### SUMMARY

Analysis of digital images of histology slides containing tissue samples is typically performed by a lab technician. Gross errors may affect results of a histopathology analysis. In some cases, gross errors can be easily identifiable by a technician at a low zoom level or with the naked eye. Identification of smaller errors, such a blurry regions, may be more difficult and time consuming. Therefore, there exists a need for systems and methods to automate or provide automated assistance to identify errors within digital images of histology slides.

Provided herein are embodiments of a method of performing quality control comprising: receiving a digital micrograph representing a slide with a tissue sample; performing a first-stage quality review of the digital micrograph at a first magnification, the first-stage quality review comprising: applying a plurality of first machine learning models, each first machine learning model trained to identify a particular quality failure case; performing a second-stage quality review of the digital micrograph at a second magnification, the second-stage quality review comprising: identifying a plurality of patches covering the tissue sample; applying a second machine learning model to each patch to identify a blur failure case for the patch; and determining a blur failure case for the digital micrograph based on blur failure cases identified for the patches; and generating a quality control report for the digital micrograph.

In some embodiments, the digital micrograph is a zoomable image comprising at least 30,000, at least 40,000, or at least 50,000 static digital images. In some embodiments, the digital micrograph is a light micrograph. In some embodiments, the light micrograph is a bright field micrograph. In some embodiments, the light micrograph is a fluorescence micrograph.

In some embodiments, the tissue sample is a human tissue sample. In some embodiments, the tissue sample is a veterinary tissue sample.

In some embodiments, at least one of the quality failure cases is selected from the group consisting of: tissue fold, tissue tear, tissue separation, tissue crack, inadequate stain, incorrect stain, missing stain, cover slip issue, missing coverslip, dirty coverslip, air bubble, dirty slide, floater, blade mark, microvibration, cutting issue, blurry content, scanner artifact, not enough tissue, incorrect tissue, and combinations thereof.

In some embodiments, the second magnification is higher than the first magnification. In some embodiments, the first magnification is about 1× to about 4× or a corresponding digital image resolution of about 10 micrometers (microns) per pixel (mpp) to about 2.5 mpp. In some embodiments, the second magnification is about 20× to about 100× or a corresponding digital image resolution of about 0.5 mpp to about 0.1 mpp.

In some embodiments, at least one of the first machine learning models comprises one or more neural networks. In some embodiments, the one or more neural networks comprises one or more deep convolutional neural networks. In some embodiments, the plurality of first machine learning models are only applied to regions of the slide identified as containing tissue.

In some embodiments, the plurality of patches comprises at least 30, at least 40, or at least 50 patches. In some embodiments, the plurality of patches covers at least 30%, at least 40%, or at least 50% of the tissue sample. In some embodiments, each patch is about 512 pixels by 512 pixels.

In some embodiments, the second machine learning model comprises one or more neural networks. In some embodiments, the one or more neural networks comprises one or more deep convolutional neural networks. In some embodiments, determining a blur failure case for the digital micrograph comprises calculating statistics across blur failure cases identified for the patches or a blur probability score assigned to each patch. In some embodiments, determining a blur failure case for the digital micrograph comprises calculating a 95th percentile of blur failure cases identified for the patches.

In some embodiments, the method further comprises training each first machine learning model to identify a particular quality failure case utilizing an annotated training data set. In some embodiments, the method further comprises training the second machine learning model to identify a blur failure case utilizing an annotated training data set. In some embodiments, the method further comprises validating a sensitivity and a specificity of each first machine learning model in identifying a quality failure case. In some embodiments, the method further comprises validating a sensitivity and a specificity of the second machine learning model in identifying a blur failure case.

In some embodiments, the method further comprises processing the tissue sample and preparing the slide. In some embodiments, the method further comprises performing a human macroscopic review of the slide and the tissue sample prior to generating the digital micrograph. In some embodiments, the method further comprises scanning and digitizing the slide to generate the digital micrograph.

In some embodiments, the quality control report comprises one or more quality scores. In some embodiments, the quality control report comprises one or more quality recommendations. In some embodiments, the quality control report comprises one or more corrective recommendations. In some embodiments, the quality control report comprises one or more visual presentations of problematic slide regions. In some embodiments, the quality control report is integrated with the digital micrograph as metadata.

In some embodiments, the method further comprises storing the digital micrograph in an archival system. In some embodiments, the steps are automated and performed by a computing platform. In some embodiments, the method further comprises performing a human review of all or a subset of results of the first-stage quality review. In some embodiments, the method further comprises performing a human review of all or a subset of results of the second-stage quality review.

In some embodiments, if at the first-stage quality review, one or more of the first machine learning models identifies a quality failure case, the digital micrograph is rejected and the second-stage quality review is not performed. In some embodiments, the method further comprises providing a viewer application configured to view the digital micrograph, wherein the view application displays one or more aspects of the quality control report in association with the digital micrograph. In some embodiments, the first-stage quality review, for each first machine learning model, comprises: identifying a plurality of patches covering the tissue sample, the slide, or both; applying the first machine learning model to each patch to identify a failure case for the patch; and determining a failure case for the digital micrograph based on failure cases identified for the patches.

Provided herein are embodiments, of system comprising: at least one processor, a memory, and instructions executable by the at least one processor to create a quality control application comprising: a software module receiving a digital micrograph representing a slide with a tissue sample; a software module performing a first-stage quality review of the digital micrograph at a first magnification, the first-stage quality review comprising: applying a plurality of first machine learning models, each first machine learning model trained to identify a particular quality failure case; a software module performing a second-stage quality review of the digital micrograph at a second magnification, the second-stage quality review comprising: identifying a plurality of patches covering the tissue sample; applying a second machine learning model to each patch to identify a blur failure case for the patch; and determining a blur failure case for the digital micrograph based on blur failure cases identified for the patches; and a software module generating a quality control report for the digital micrograph.

Provided herein are embodiments of a non-transitory computer-readable storage media encoded with a computer program including instructions executable by a processor to create a quality control application comprising: an intake module configured to receive a digital micrograph representing a slide with a tissue sample; a first quality control module configured to perform a first-stage quality review of the digital micrograph at a first magnification, the first-stage quality review comprising: applying a plurality of first machine learning models, each first machine learning model trained to identify a particular quality failure case; a second quality control module configured to perform a second-stage quality review of the digital micrograph at a second magnification, the second-stage quality review comprising: identifying a plurality of patches covering the tissue sample; applying a second machine learning model to each patch to identify a blur failure case for the patch; and determining a blur failure case for the digital micrograph based on blur failure cases identified for the patches; and a report module configured to generate a quality control report for the digital micrograph.

Provided herein are embodiments of a platform comprising a digital scanner and a computing device: the digital scanner communicatively coupled to the computing device; and the computing device comprising at least one processor, a memory, and instructions executable by the at least one processor to create quality control application comprising: a software module receiving, from the digital scanner, a digital micrograph representing a slide with a tissue sample; a software module performing a first-stage quality review of the digital micrograph at a first magnification, the first-stage quality review comprising: applying a plurality of first machine learning models, each first machine learning model trained to identify a particular quality failure case; a software module performing a second-stage quality review of the digital micrograph at a second magnification, the second-stage quality review comprising: identifying a plurality of patches covering the tissue sample; applying a second machine learning model to each patch to identify a blur failure case for the patch; and determining a blur failure case for the digital micrograph based on blur failure cases identified for the patches; and a software module generating a quality control report for the digital micrograph.

Provided herein are embodiment of a method of performing quality control comprising: receiving a digital micrograph representing a slide with a tissue sample; performing a quality review of the digital micrograph comprising: applying a plurality of machine learning models, each machine learning model trained to identify a particular quality failure case; wherein applying at least one of the plurality of machine learning models comprises: identifying a plurality of patches covering the tissue sample, the slide, or both; applying the machine learning model to each patch to identify a failure case for the patch; and determining a failure case for the digital micrograph based on failure cases identified for the patches; wherein at least one of the plurality of machine learning models is applied to the digital micrograph at a first magnification and at least one of the plurality of machine learning models is applied to the digital micrograph at a second magnification; and generating a quality control report for the digital micrograph.

In some embodiments, the digital micrograph is a zoomable image comprising at least 30,000, at least 40,000, or at least 50,000 static digital images. In some embodiments, the digital micrograph is a light micrograph. In some embodiments, the light micrograph is a bright field micrograph. In some embodiments, the light micrograph is a fluorescence micrograph. In some embodiments, the tissue sample is a human tissue sample. In some embodiments, the tissue sample is a veterinary tissue sample.

In some embodiments, at least one of the quality failure cases is selected from the group consisting of: blur, tissue fold, tissue tear, tissue separation, tissue crack, inadequate stain, incorrect stain, missing stain, cover slip issue, missing coverslip, dirty coverslip, air bubble, dirty slide, floater, blade mark, microvibration, cutting issue, blurry content, scanner artifact, not enough tissue, incorrect tissue, and combinations thereof.

In some embodiments, the first magnification is about 1× to about 4× or a corresponding digital image resolution of about 10 micrometers (microns) per pixel (mpp) to about 2.5 mpp. In some embodiments, the second magnification is about 20× to about 100× or a corresponding digital image resolution of about 0.5 mpp to about 0.1 mpp. In some embodiments, at least one of the machine learning models comprises one or more neural networks. In some embodiments, the one or more neural networks comprises one or more deep convolutional neural networks. In some embodiments, the plurality of machine learning models are only applied to regions of the slide identified as containing tissue.

In some embodiments, the plurality of patches comprises at least 30, at least 40, or at least 50 patches. In some embodiments, the plurality of patches covers at least 30%, at least 40%, or at least 50% of the tissue sample or the slide. In some embodiments, each patch is about 512 pixels by 512 pixels. In some embodiments, determining a failure case for the digital micrograph comprises calculating statistics across failure cases identified for the patches or a probability score assigned to each patch. In some embodiments, determining a failure case for the digital micrograph comprises calculating a 95th percentile of failure cases identified for the patches.

In some embodiments, the method further comprises training each machine learning model to identify a particular quality failure case utilizing an annotated training data set. In some embodiments, the method further comprises validating a sensitivity and a specificity of each machine learning model in identifying a quality failure case. In some embodiments, the method further comprises processing the tissue sample and preparing the slide. In some embodiments, the method further comprises performing a human macroscopic review of the slide and the tissue sample prior to generating the digital micrograph. In some embodiments, the method further comprises scanning and digitizing the slide to generate the digital micrograph.

In some embodiments, the quality control report comprises one or more quality scores. In some embodiments, the quality control report comprises one or more quality recommendations. In some embodiments, the quality control report comprises one or more corrective recommendations. In some embodiments, the quality control report comprises one or more visual presentations of problematic slide regions. In some embodiments, the quality control report is integrated with the digital micrograph as metadata.

In some embodiments, the method further comprises storing the digital micrograph in an archival system. In some embodiments, the steps are automated and performed by a computing platform. In some embodiments, the method further comprises performing a human review of all or a subset of results of the quality review. In some embodiments, the method further comprises providing a viewer application configured to view the digital micrograph, wherein the view application displays one or more aspects of the quality control report in association with the digital micrograph.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The novel features of the subject matter described herein are set forth with particularity in the appended claims. A better understanding of the features and advantages of the present subject matter will be obtained by reference to the following detailed description that sets forth illustrative embodiments, in which the principles of the present subject matter are utilized, and the accompanying drawings of which:

FIG. 1 shows a non-limiting example of a computing device; in this case, a device with one or more processors, memory, storage, and a network interface;

FIG. 2 depicts a non-limiting example of workflow of receiving and processing an order for analysis of a sample;

FIG. 3 depicts a non-limiting example of a lab information management system;

FIG. 4 depicts a non-limiting example of results from a quality control tool;

FIG. 5 depicts non-limiting examples of image patch regions of a digital micrograph;

FIG. 6 depicts a non-limiting example of a histology slide which has been analyzed using image patch regions;

FIG. 7 depicts a non-limiting example of a blur analysis of a plurality of image patch regions of a histology slide performed on the histology slide of FIG. 6;

FIG. 8 depicts a non-limiting example of a histology slide which has been analyzed using image patch regions;

FIG. 9 depicts a non-limiting example of a blur analysis of a plurality of image patch regions of a histology slide performed on the histology slide of FIG. 8;

FIG. 10 depicts a non-limiting example of a histology slide which has been analyzed using image patch regions;

FIG. 11 shows a high resolution image of a portion of the histology slide of FIG. 10;

FIG. 12 depicts a non-limiting example of a blur analysis of a plurality of image patch regions of a histology slide performed on the portion of the histology slide of FIG. 11;

FIG. 13 depicts a non-limiting example of a histology slide which has been analyzed using image patch regions;

FIG. 14 depicts a non-limiting example of a histology slide which has been analyzed using image patch regions;

FIG. 15 depicts a non-limiting example of a blur analysis of image patch regions of the histology slide of FIG. 13 and FIG. 14;

FIG. 16 depicts a non-limiting example of a method for reviewing histology slides;

FIG. 17 depicts a non-limiting example of a method for reviewing histology slides;

FIG. 18 depicts a non-limiting example of a method for reviewing histology slides;

FIG. 19 depicts a non-limiting example of a color code system for analyzing a histology slide;

FIGS. 20A-20E depict non-limiting examples of a graphical user interface for assessing quality of a histology slide; and

FIGS. 21A-21D depict non-limiting examples of a graphical user interface for assessing quality of a histology slide.

### DETAILED DESCRIPTION

Provided herein are systems and methods for automation of quality control of histology slides. In some embodiments, the systems and methods herein perform an automated analysis of histology slides for detecting issues in preparation and scanning of histology slides. In some embodiments, issues in preparation and scanning of histology slides detectable by the systems and methods herein include blurriness, folds in the slides, tears in the slides, cover slip misalignment, blade marks, deep cuts, scanner artifacts, inadequate staining, and not enough tissue present on a slide. In some embodiments, if a quality threshold is not met due to issues with a histology slide, the slide is rejected. Rejected slides may be reprocessed and rescanned.

In some embodiments, blurriness of a histology slide is assessed at a zoom level of 20× to 40×. Because the increased zoom level, assessment of levels of blurriness across an entire histology slide may be more time consuming than the assessment of other issues which may arise during the preparation and scanning of histology slides.

In some embodiments, systems and methods herein detect blurry histology slides by assessing a plurality of high resolution image patches sampled from an entire image of the histology slides. In some embodiments, the high resolution image patches are each assessed by a neural network to detect blur within the patches. In some embodiments, the individual assessments of each of the image patches are aggregated to determine if the entire histology slide should be rejected due to the overall blurriness present within the slide.

### I. WORKFLOW

A. Order Form

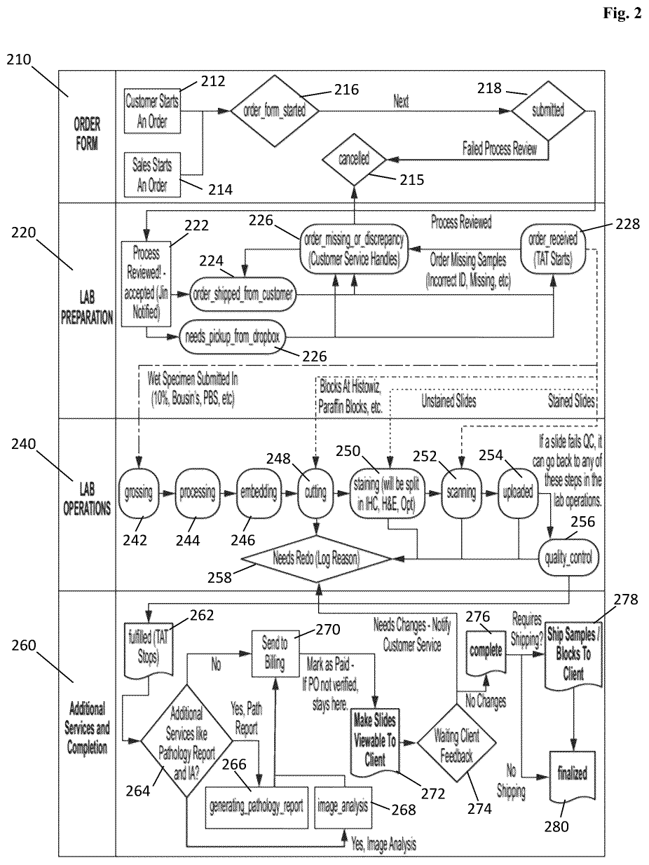

In some embodiments, the methods herein further comprise receiving and processing orders for a histological analysis. With reference to FIG. 2, an embodiment of a workflow for a histological analysis is depicted. In some embodiments, the histopathology analysis begins with initiation of an order at step 210. In some embodiments, the order form comprises information about a subject, from which a tissue sample is provided for a histological analysis. Subject information included on the order form may comprise a species of a subject, a location from which the tissue sample was obtained, a description of the region from which the tissue sample was obtained, an image of the region from which the tissue sample was obtained, an image of the region from which the tissue sample was obtained prior to a biopsy, an age of the subject, an image of the region from which the tissue sample was obtained after a biopsy, the organ from which the tissue sample was obtained from; a description of the fixative solution in which the specimen is stored; a description of the strain (e.g., for a mouse obtained specimen the description may include a genetic mutation strain such as nude or SCID mice), a gender of the specimen, and symptoms and/or ailments of the subject to be further analyzed by the histological analysis.

In some embodiments, the subject is a human and the tissue sample is a human tissue sample. In some embodiments, the subject is an animal and the tissue sample is a veterinary tissue sample. In some embodiments, an order form comprises information such as a date of birth of a subject, a medical history of the subject, a description of symptoms experienced by the subject, the name of the subject, the residence of the subject, contact information for the subject, emergency contact information for the subject, and other information which is useful in identifying a subject or assessing a tissue sample. In some embodiments, human samples are processed for research purposes. In some embodiments, samples are deidentified prior to processing.

In some embodiments, at step 212, an order is initiated by a member of a sales team. In some embodiments, the sales team member is an employee of a laboratory for processing and analyzing histology slides. In some embodiments, the sales team member advocates for the lab or company to process the histology slides. In some embodiments, the sales team member receives the subject information and processes the information to fill out an order form. In some embodiments, at step 214, the order is initiated by a customer. A customer may include a physician, a researcher/scientist, a medical professional, or a legal professional submitting samples for an expert opinion.

In some embodiments, at step 216, an order form is started. In some embodiments, the order form is digital. The order form may be presented as a fillable form or web application. The order form may provide a graphical user interface to guide a customer or sales team member through input fields in order to obtain the information necessary to accurately process a sample and assign the sample to the subject.

In some embodiments, a sales team member assists a customer with filling out an order form. In some embodiments, a web application allows a sales team member to view and fill out the order form with the customer in real-time. In some embodiments, a sales team member communicates with the customer via an online chat during filling of an order form. In some embodiments, a sales team member communicates with the customer via phone during filling of an order form.

In some embodiments, the completed order form is then submitted, at step 218, to the laboratory which will be processing and analyzing the sample. In some embodiments, the submitted order form is then reviewed. During the review, a submitted order form may be analyzed to ensure all necessary information has been filled out. In some embodiments, information provided on the form is verified. In some embodiments, if the order form is missing critical information or appears to be incorrect then a representative will contact the client to resolve any discrepancies. In some embodiments, if it is determined that an order will be impossible to complete given the capabilities of the laboratory, then the order will be cancelled at step 215. In some embodiments, upon cancellation of an order the customer and/or sales team member will receive a notification. A cancellation notification may include reasons as to why the order has been cancelled.

In some embodiments, if the order form is correctly filled out then the order will be accepted at step 222. In some embodiments, an accepted order will be flagged for the laboratory team, such that they can expect to receive a sample or be notified of a location to pick up a sample to be processed and analyzed. In some embodiments, the laboratory provides a notification to a client. Notifications may be electronic notifications sent by email, text message, or other means. Notifications may include an alert that an order has been received and an alert that an order has been accepted. In some embodiments, a notification informing a client that the order has been accepted includes a shipping label for shipping the tissue sample.

B. Lab Preparation

In some embodiments, at step 220, preparation of a sample begins once an order has been accepted at step 222. In some embodiments, a client receives a notification that preparation of a sample has begun. If a sample is to be shipped to the laboratory, at step 224 then a notification may be received by the lab team, such that they can expect to receive the sample via shipping. In some embodiments, a member of the lab team picks up a sample from a drop box. The drop box may be provided within the lab, such that samples taken at the same facility may be placed in the drop box and picked up by a lab member for sampling.

At step 228, the order is received by the lab. In some embodiments, the order comprises one or more tissue samples. In some embodiments, the order comprises unstained histology slides. In some embodiments, the order comprises stained histology slides. In some embodiments, the order is checked to ensure the proper contents have been received. At step 226, if the order is missing samples or any discrepancies are present in the order then the order may be flagged. A flagged order may trigger a request for new samples to be shipped by the customer. In some embodiments, a flagged order will alert a sales representative who will reach out to the client to resolve any issues. In some embodiments, orders are marked as ‘pending’ until issues and/or discrepancies are resolved or a new sample is received. This may prevent improper identification of the orders and misdiagnosis.

C. Automated Histology/Lab Operations

In some embodiments, at step 240, the lab receives the sample and begins processing the sample. The sample may be received by the lab in one or more states of processing. In some embodiments, the sample is received by the lab is a wet sample, a fresh sample, a frozen sample, a fixed sample, a sample provided in neutral buffered formalin solution, sample provided in a Bouin solution, a sample provided in a phosphate buffered saline (PBS) solution, or a sample provided in another acceptable state or form. In some embodiments, the sample received by the lab is embedded. In some embodiments, the sample received by the lab has been sectioned into unstained glass slides. In some embodiments, the sample received by the lab has been sectioned into glass slides and stained.

In some embodiments, grossing begins at step 242, immediately after receiving the sample. During grossing, the sample maybe inspected to identify improper sampling, preparation, handling, or imperfections prior to processing (e.g., in cassette molds) of the samples, which may affect the results of the analysis. In some embodiments, grossing includes taking measurements of the samples. In some embodiments, grossing includes determining how to cut a sample, such as bisecting or trisecting, where necessary to capture a region of interest or fit into a cassette mold for embedding. In some embodiments, a region of interest is specified in the instructions of an order, and the sample is cut accordingly to capture the region of interest. In some embodiments, grossing details are entered into the laboratory information system.

If a sample received by the lab has yet to be embedded, then the sample may undergo processing at step 244. Processing may comprise fixation of the sample. In some embodiments, processing of the sample may comprise dehydration to remove water from the sample. Dehydration may comprise immersing samples in a dehydrating solutions. In some embodiments, concentrations of dehydrating solutions are increased gradually to avoid distortion of the tissue sample. Dehydrating solutions may comprise acetone, butanol, Cellosolve, dimethoxypropane (DMP), diethoxypropane (DEP), dioxane, ethanol, methanol, isopropanol, polyethylene glycol, tetrahydrofuran, or other suitable dehydrating solutions.

In some embodiments, processing further comprises clearing of the dehydrating solution. In some embodiments, a clearing agent or intermediary fluid, which is miscible with an embedding media, replaces the dehydration solution. Exemplary clearing agents may include, but are not limited to xylene, toluene, chloroform, orange oil based solutions, and methyl salicylate, amyl acetate, methyl benzoate, methyl salicylate, benzene, butyl acetate, carbon tetrachloride, cedarwood oil, limonene, methyl benzoate, tepenes, trichloroethane, and other suitable clearing agents. In some embodiments, clearing the dehydrating solution is an automated process. Clearing may be accomplished in a span of about 1 hour to 24 hours, depending on the size of the tissue sample.

In some embodiments, the sample then undergoes embedding at step 246. In some embodiments, embedding comprises infiltrating the tissue sample with an embedding medium to provide a support to allow the tissue sample to be cut or sectioned into thin slices to be provided on a slide. In some embodiments, an embedding medium comprises paraffin wax, ester wax, plasticizers, epoxy resin, acrylic resin, acrylic agar, gelatin, celloidin, water-soluble wax, other types of waxes, or other suitable embedding material mediums. In some embodiments, frozen samples are placed in a water-based embedding medium such as water-based glycol, an optimal cutting temperature (OCT) compound, tris-buffered saline (TBS), Cryogel, or resin. In some embodiments, the embedding medium and the tissue samples are placed in a mold.

In some embodiments, an embedded sample undergoes cutting or sectioning at step 248. In some embodiments, the sample received by the laboratory is already an embedded tissue sample, which is sent straight to the cutting or sectioning operations at step 248. In some embodiments, a microtome comprising a blade is used to cut tissue sections. In some embodiments, the blade is a glass or diamond blade. In some embodiments, the sample is cut using an ultramicrotome. In some embodiments, samples are cut into sections about 2 to 15 micrometers thick.

In some embodiments, the cut sections are placed into a water bath to help tissue expand and smooth out the sections. In some embodiments, the sections are picked up onto a slide from the water bath. In some embodiments, the slide containing the section of the embedded tissue is warmed to facilitate adhesion of the sample to the slide and drying of the embedded sample.

In some embodiments, after the sample is prepared and placed on to slide, the sample is stained at step 250 to provide contrast between cell types and highlight features of interest within the sample. In some embodiments, samples are sent to the laboratory as unstained histology slides and are immediate sent to be stained at step 250. In some embodiments, a solvent is used to remove the embedding medium from the tissue. In some embodiments, the tissue sample is stained using hematoxylin and eosin (H&E stain). In some embodiments, the tissue sample is stained using an immunohistochemistry staining process wherein chromagen-labeled antibodies are bound to the tissue sample. In some embodiments, the tissue sample is stained using an immunofluorescence staining process wherein fluorescent-labeled antibodies are bound to the tissue sample. Other stains or staining methods may be utilized. In some embodiments, a coverslip is placed over the tissue samples after they have been stained.

Stained tissue samples provided on histology slides are then scanned at step 252. In some embodiments, samples are sent to the laboratory as stained histology slides and are immediate scanned at step 252. The scanned slides may then be uploaded to a database or saved to a local memory at step 254. The scanned slides may then be evaluated and analyzed at step 256 during quality control to ensure that the captured images of the slides are of high enough quality such that a proper analysis of the slides may be performed. The quality control performed at step 256 may comprise high resolution analysis of a plurality of image patches from each histology slide, as disclosed herein. The quality control analysis may be automated as disclosed herein. In some embodiments, an automated quality control analysis utilized a trained neural network to analyze images of the histology slides to assess the quality of the images. If a histology slide fails at the quality control step, it may be sent back to be reprocessed at any one of the sample preparation steps. In some embodiments, automated systems recognize which preparation step should be revisited in order to obtain a successful histology slide.

In some embodiments, some of the lab operations are automated. In some embodiments, all lab operations are automated. In some embodiments, automated systems are utilized to provide the tissue samples through each stage of processing. Automated systems may include conveyor belts, robotic arms, or the like, to transfer the samples between stations which the processing stages take place.

In some embodiments, identification of gross errors occurs throughout the preparation of the tissue samples. In some embodiments, identification of gross errors is accomplished by a technician trained to recognize errors or imperfections during preparation of the samples. In some embodiments, automated system utilizing cameras are setup at various locations during preparations of the tissue samples to recognize errors or imperfections during preparation of the samples. If an error or imperfection is recognized a tissue sample during processing, it may be sent back to be reprocessed at any one of the sample preparation steps. In some embodiments, automated systems recognize which preparation step should be revisited in order to correct the error or imperfection.

D. Pathology Database/Additional Services and Completion

In some embodiments, after the images of the slides are scanned, they are uploaded to a pathology database. The pathology database may be accessible to computing devices external to the network. In some embodiments, images of the slides are provided as digital zoom images.

After histology slides are scanned and subjected to the quality control methods disclosed herein, the lab may provide additional services and complete the order at step 260. In some embodiments, after the slides are processed in quality control the order is considered fulfilled at step 262. In some embodiments, a turnaround time is measured from when the order/sample is received by the lab, at step 228, to when the order is considered fulfilled at step 262. In some embodiments, at step 264, additional services such as providing a pathology report and performing an image analysis are considered. In some embodiments, a pathology report is generated, at step 266, from using the digital images of the tissue samples. In some embodiments, the pathology report is provided by a technician. In some embodiments, digital images of slides are automatically tagged with labels indicating cell types for a histopathological analysis. In some embodiments, a histopathological analysis is performed by a pathologist. In some embodiments, a histopathological analysis is automated. In some embodiments, at step 268, a qualitative image analysis is performed on the digital images of the histology slides. In some embodiments, a qualitative image analysis is automated.

In some embodiments, at step 270, the order is provided to a billing system. In some embodiments, the order is held until payment is provided. In some embodiments, once payment is provided the digital images of the slides are provided to the client at step 272. In some embodiments, the images are provided as digital zoom images. In some embodiments, the images are accessible via a web application. In some embodiments, after viewing the digital images of the tissue samples, the client provides feedback at step 274. If the client does not require any changes, then the order may be marked as complete at step 276. If the client requests changes, then the request may be logged and the order may be reprocessed at step 258.

Once an order is considered complete, the samples may be shipped to the client at step 278. In some embodiments, a client must submit a request to have the samples shipped back to them. The order may then be marked as finalized, at step 280. If the client does not request the samples, then the samples may be held at the lab or disposed of, and the order will be marked as finalized.

### II. LABORATORY INFORMATION MANAGEMENT SYSTEM (LIMS)

A laboratory information management system (LIMS) provides an efficient means of providing and updating the status of orders, samples, and slides to manage workflows of multiple orders. The LIMS systems also facilitates access to order and sample information, as well as access to digital images of slides corresponding to orders/samples.

In some embodiments, provided herein is laboratory information management system (LIMS). In some embodiments, the LIMS provides a staff interface (i.e. backend interface) for laboratory staff to manage orders for processing and/or analysis of samples, digital images of samples, and digital micrographs of samples. In some embodiments, the samples are stained. In some embodiments, the samples are placed onto a slide to form a histology slide.

With reference to FIG. 3, in some embodiments, the LIMS is accessible via a computing device 305, 310 external to the LIMS. In some embodiments, the external computing device is a mobile computing device 310. In some embodiments, access to a staff interface of the LIMS requires authentication or verification. In some embodiments, single-factor authentication, two-factor authentication, multi-factor authentication, single sign-on authentication, or a combination thereof is used to access a staff interface of the LIMS.

In some embodiments, the staff interface of the LIMS provides a library of orders which have been submitted, are in progress, and have been completed. In some embodiments, orders are categorized by their current status or state.

In some embodiments, the orders are categorized by their current status within a lab review process. This may include steps completed as part of initializing an order or lab preparation (e.g., initiation of an order 210 and/or lab preparations 220 steps as depicted by FIG. 2). In some embodiments, selectable lab review statuses include open orders, open immunofluorescence (IF) orders, in progress immunohistochemistry (IHC) staining orders, special stain orders, IHC optimization orders, late orders, unfulfilled orders, open orders due by specified date, orders which need to be assigned a turnaround time, orders which are pending, orders which need to be recut, finalized orders, and all orders. Orders may be accessible through selection one or more of the provided status categories.

In some embodiments, orders are provided by the status within the lab workflow. This may include steps completed as part of the automated histology and lab operations (e.g., lab operations 230 as depicted in FIG. 2) In some embodiments, selectable lab workflow statuses include orders which need a process review, orders which need payment, orders which have been shipped, orders which have been received, orders to be grossed, orders to be embedded, orders to be cut, orders to be stained, orders to be screened, orders ready to be filled, completed orders, and orders pending shipment. Orders may be available in one or more of the provided status categories.

In some embodiments, the orders are provided by the status within a customer service workflow. In some embodiments, selectable customer service workflow categories include orders which need image analysis or pathology consultation, orders which need client feedback, and orders which need to be invoiced or billing adjustments. Orders may be accessible through selection one or more of the provided status categories.

In some embodiments, the LIMS provides accessibility to processed samples and slides via categorization. In some embodiments, selection of a sample or histology slide also allows access to the corresponding order form. In some embodiments, histology slides are categorized and accessible via the LIMS by their status in the lab workflow. In some embodiments, slide categories include slides which need a quality control review, slides which need to be recut, slides which need to be rescanned, slides which have failed any aspect of quality control, samples wherein antibody slides have been requested, samples wherein special stains have been requested, samples wherein a channel filter slide has been requested, all slides, all samples, slide comments.

In some embodiments, pathology consultation orders are accessible via the LIMS. In some embodiments, team or user management databases are also provided via the LIMS. In some embodiments, staff and team information is sorted and accessible by users, teams, team addresses, organizations, projects, and billing contacts. In some embodiments, the LIMS provides access to orders through libraries categorized by a specific user, technician, or team. IN some embodiments, the LIMS provides access to orders through libraries belonging to a specific organization, project, or billing contact. In some embodiments, the LIMS provides access to orders and slides via categorization of components utilized in preparing samples. In some embodiments, orders and slides are accessible via categorization of antibodies, antibody application, antibody attachments, sample submissions, species types, special stains, organ types, fixatives used, and immunofluorescent channel filters used.

In some embodiments, categorization and/or sorting of the orders by the above mentioned statuses/categories allows personnel to access orders which are relevant to their role or specialization. For example, a technician who specializes in grossing may select the grossing library to access all orders which are to be reviewed for gross errors in the. Upon a selection of an order, the technician may be provided with information specific to the work their role. For example, a technician who specialized in grossing will be provided with information relevant to the grossing process. The information relevant to the grossing process may be provided by a field in the order form completed by a client or a staff member.

In some embodiments, the technician is provided with selectable options to update or change the status for an order. For example, a technician specializing in cutting samples may select a ‘cutting complete’ button to confirm cutting of an embedded sample has been performed. In some embodiments, the LIMS provides a process history of each order. In some embodiments, the process history lists each updated or change status for an order. In some embodiments, an order process history lists the technician or staff member who made the update or change. Each status change may be recorded and presented in the process history. Each status change may provide the received status and the updated status for each instance. In some embodiments, wherein processes are automatically performed, a status change is automatically entered and recorded. In the case of an automated status change entry, the field which typically lists a technician or staff member may be entered as ‘none’ or ‘automated’.

In some embodiments, upon selection of an order, information regarding the order is presented to the user. In some embodiments, order information includes associated samples. The LIMS may further provide information attributed to the samples such as stain/unstained, stain type, requested IHC antibody names, requested IF channels, requested pathology consultations, species type, organ type, if the sample is of a tumor, control type, indication of bone decalcification, fixation time, and cut type.

In some embodiments, updates, edits, comments, or any information input into the LIMS by a staff member triggers notifications to other team members if relevant. Notifications may be sent via email or via a business based communication system, such as slack. Notifications may be automatically triggered by submission of the information by a staff member or may be pushed by a selection made by the staff member entering the information. In some embodiments, a dedicated group of web machines 325 is responsible for pushing notifications via connected software applications.

In some embodiments, the LIMS provides a customer-facing user interface. In some embodiments, actions completed on the customer-facing or frontend interface application programing interface (API) operations will be sent to the LIMS. In some operations, actions completed in the customer-facing interface will be recorded and provided within the staff interface. In some embodiments, a customer using the frontend interface will click a button provided on the interface to save any information which has been entered in available fields of an order form. The submitted information may be immediate available to be viewed by staff on a staff or backend interface. In some embodiments, upon processing of a sample to create a digital image of a histology slides, scanned images of histology slides will be made available on the user facing interface. In some embodiments, using the staff-facing interface, a technician or staff member is able to access the digital images of the histology slides, which are available to the user, via selecting an order and selecting slides which correspond to said order. This may help facilitate the user experience.

A. Information Management System Configuration

With reference to FIG. 3, a system for analyzing digital micrographs representing a slide with a tissue sample and processing a customer order, is depicted according to some embodiments. In some embodiments, scanners 350 are provided to scan and produce digital images or a digital micrograph representing a histology slide. In some embodiments, the scanners 350 are connected to a network drive 355, such that the images obtained by the scanners 350 are uploaded to the network drive 355. In some embodiments, one or more computing devices 360 are connected to the network drive 355. In some embodiments, the computing device 360 uploads data from stored files on the network drive 355 to a cloud storage database or datastore 365. In some embodiments, the cloud storage datastore 365 is configured as a temporary storage datastore. In some embodiments, the cloud storage datastore 365 automatically achieves files after a duration of time. In some embodiments, the cloud storage datastore 365 automatically achieves files after 60 days. In some embodiments, the cloud storage datastore is provided by the Google Cloud Platform application.

In some embodiments, the system comprises an external user computing device 305 or an external mobile computing device 310. In some embodiments, the external computing device 305, 310 connects to an origin server 315. The origin server 315 connects the external computing device 305, 310 to a cloud balancing virtual private network (VPN) 320. In some embodiments, the cloud balancing VPN 320 is further connected to one or more web machines 325. In some embodiments, the web machines 325 perform tasks such as error monitoring, error reporting, sending notifications via email or other services (e.g., Slack), log significant events of the system, and create a paper trail of activates/tasks performed by the system. In some embodiments, the web machines 325 send tasks to a group of asynchronous computational devices 380.

In some embodiments, the asynchronous computational devices 380 are configured for algorithmic image solving. In some embodiments, the asynchronous computational devices 380 carry out the image processing and analysis disclosed herein. In some embodiments, the computational devices 380 analyze and detect errors or imperfections present in histology slides. In some embodiments, computational devices 380 detect levels of blurriness present in digital representations of histology slides.

In some embodiments, the computational devices 380 detect features of a tissue sample provided on a histology slide.

In some embodiments, the computational working devices 380 are CPU optimized. In some embodiments, the computation working devices 380 comprises at least one processor, a memory, and instructions executable by the at least one processor to carry out the methods disclosed herein. In some embodiments, a plurality of computation working devices 380 each comprise at least one processor. In some embodiments, a plurality of computation working devices 380 each comprise at least one processor a memory. In some embodiments, the computational devices 380 are connected to a VPN. In some embodiments, the computational devices 380 are configured to assess high resolution image patches of histology slides.

In some embodiments, the system further comprises a communication medium 370. The communication medium 370 may be connected to the first cloud storage data base 365 and the cloud balancing VPN 320. In some embodiments, the communication medium provides the files from the first cloud storage datastore 365 to the cloud balancing VPN 320, which in turn provides files to the web machines 325, and finally to the computational devices 380 for processing. In some embodiments, the communication medium 370 is provided by Google Pub/Sub.

In some embodiments, computational devices 380 process the digital images of the histology slides to output a digital zoom image (DZI). The DZI files may be transferred to a second cloud storage datastore 390 along with the original images from the scanners. In some embodiments, a cloud server datastore 395 is updated to indicate that processing of the images is complete. In some embodiments, the cloud server datastore 395 is provided by Google Cloud SQL. In some embodiments, the DZI files are transferred to the first cloud datastore 365, through the communication medium 370, through the cloud balancing VPN 320, and processed by the web machines 325 report errors, send notifications via email or other services (e.g., Slack), log significant events of the system, and create a paper trail of activates/tasks performed by the system.

### III. AUTOMATED QUALITY CONTROL

In some embodiments, provided herein are system and methods for automated quality control of histology slides. In some embodiments, automated quality control methods are carried out in a two-stage process. In some embodiments, the image resolution and/or zoom level of the second stage of analysis is higher than image resolution and/or zoom level of the first stage of quality control analysis.

In some embodiments, a first stage comprises a low resolution review of the histology slides. The low resolution review may be carried out at a zoom level of about 1× to 4×. In some embodiments, the low resolution review comprises identifying errors or imperfections such as tissue folds, tissue tears, tissue separations, tissue cracks, inadequate stains, incorrect stains, missing stains, coverslip issues, missing coverslips, dirty coverslips, air bubbles, dirty slides, floaters, blade marks, microvibrations, scanner artifacts, not enough tissue, incorrect tissue, and combinations thereof. In some embodiments, the low resolution review further comprises identifying blurriness in a digital image of a histology slide.

In some embodiments, a second stage of the quality control methods comprises a high-resolution review of the histology slides. In some embodiments, the high resolution review is carried out at a zoom level of about 20× to 40×. In some embodiments, the second stage review analyzes a blurriness of the histology slide being examined. In some embodiments, blurriness in histology slides is detected by assessing a plurality of high resolution image patches sampled from an entire image of the histology slides. In some embodiments, the high resolution image patches are each assessed by a neural network to detect blur within the patches. In some embodiments, the individual assessments of each of the image patches are aggregated to determine if the entire histology slide should be rejected due to the overall blurriness present within the slide. Slides at either the first stage or second stage may be reprocessed, restained, and/or rescanned.

In some embodiments, automated quality control methods are carried out in a single stage, wherein the image is simultaneously analyzed at the gross level and at a higher resolution to detect issues such as tissue fold, tissue tear, tissue separation, tissue crack, inadequate stain, incorrect stain, missing stain, cover slip issue, missing coverslip, dirty coverslip, air bubble, dirty slide, floater, blade mark, microvibration, cutting issue, blurry content, scanner artifact, not enough tissue, incorrect tissue, and combinations thereof. In some embodiments, gross error detection may be carried out by a technician.

A. Gross Error Recognition

In some embodiments, histology slides are analyzed to recognize gross errors in the preparation of histology slides. In some embodiments, scanned images of the histology slides are analyzed to identify errors or imperfections such as folds in the sample, tears in the sample, cover slip misalignment, blade marks, deep cuts, scanner artifacts, inadequate staining, and not enough tissue present on a slide.

Folds in the sample may prevent accurate analysis of a histology slide due to overlap of the tissue sample. Folds in a sample may also produce errors during staining of the sample. Additionally, the folded edge of the sample may obscure the image and be detrimental to proper analysis. In some embodiments, a tissue sample is recut when a fold is identified. In some embodiments, a recut sample section is placed into a water bath for expansion and smoothing.

Tears in the samples may prevent accurate analysis due to dislocation of groups of cells within the samples. In some embodiments, a new sample is cut from the tissue block.

Coverslip misalignment may prevent accurate analysis by obscuring the image of the tissue sample with an edge of the coverslip. A coverslip may be carefully removed and repositioned (or replaced) prevent obscuring of scanned images of the tissue samples. A missing coverslip may affect the stain color, and may be remedied by application of a new cover slip. Errors in coverslip alignment may also include bubbles (e.g., air bubbles) between the cover slip and the tissue sample which may distort the digital image of the histology slide/tissue sample.

Scanner artifacts may obscure scanned images of the tissue samples. If scanner artifacts are detected, the scanning apparatus may be cleaned and the slides may be rescanned.

Inadequate staining of the slides may prevent proper analysis, as not enough contrast between features may be present. As such, feature recognition may be difficult. Slides with inadequate staining may be recut and re-stained to provide clearer contrast between features.

Blade marks caused by improper sectioning may prevent proper analysis. In some embodiments, wherein blade marks are caused by improper sectioning, the tissue sample may be remedied with through a recut with a smoother turning of the microtome wheel.

Although some errors can be fixed by reprocessing of the samples, samples having gross errors may be discarded. Discarding samples with gross errors may prevent mistakes during analysis which may prevent misdiagnosis. Some errors may be irreparable and require that the sample be discarded.

In some embodiments, gross errors may be recognized by visual inspection by a trained technician. In some embodiments, recognition of gross errors is accomplished by an automated system. In some embodiments, scanned images of the histography slides are analyzed by a software module or computer program which utilizes a machine learning model to identify gross errors. In some embodiments, images of the tissue samples are captured during preparation and a software module or computer program utilizing a machine learning model may identify gross errors as the sample is being processed.

In some embodiments, a low zoom quality control model is utilized to detect gross errors in the scanned images of the histology slides. In some embodiments, a neural network trained model is utilized to analyze a digital micrograph representative of a slide with a tissue sample. In some embodiments, a thumbnail of a slide image is processed at a 1× zoom level. In some embodiments, a low zoom quality control model analyzes a slide image at a 2× to 4× zoom level. In some embodiments, the low zoom quality control model is a first stage of a two-stage quality control method.

In some embodiments, a low zoom quality control model detects as many failure cases as possible within each slide image. Exemplary failure cases may include folds in the sample, tears in the sample, cover slip misalignment, blade marks, deep cuts, scanner artifacts, inadequate staining, and not enough tissue present on a slide. In some embodiments, the low zoom quality control model is trained to identify each failure case. In some embodiments, the low zoom quality control model is trained to identify the type of gross errors present in the image of the histology slide and present the error type to a technician, such that they may be remedied. In some embodiments, the low zoom quality control model presents suggestions as to how the errors may be corrected.

B. Blur Recognition

In some embodiments, systems and methods herein detect blurriness levels of digital representations of histology slides. In some embodiments, the digital representations of histology slides are created from scanning images of the histology slides. In some embodiments, a group of CPU optimized computational devices designed for algorithmic image solving are used to determine the level of blurriness of digital micrograph of histology slides.

While gross errors may be quickly detectable by visual inspection by a technician, detecting blurriness in a slide may take significantly longer. Detecting blurriness in a histology slide may require analysis at a higher magnification level than detection of gross errors. At higher levels of magnification, less of the stained tissue sample may be visible at any given time. This may make it difficult for a technician to accurately track and assess the overall level of blurriness of a histology slide. Additionally, only a region of a slide may be blurry and a technician might miss that region when performing a quick scan of the slide at high resolution.

In some embodiments, the systems and methods provided herein allow for automated assessment of the overall level of blurriness in a slide. In some embodiments, if the overall level of blurriness exceeds a predetermined threshold then the slide will be considered as failing. In some embodiments, a failed slide is discarded. In some embodiments, a failed slide is reprocessed.

In some embodiments, image patch regions are extracted to cover a fixed percent of the imaged tissue. In some embodiments, the percent of the imaged tissue covered by patch regions is about 10% to about 90%. In some embodiments, the percent of the imaged tissue covered by patch regions is about 10% to about 20%, about 10% to about 30%, about 10% to about 40%, about 10% to about 45%, about 10% to about 50%, about 10% to about 55%, about 10% to about 60%, about 10% to about 65%, about 10% to about 70%, about 10% to about 80%, about 10% to about 90%, about 20% to about 30%, about 20% to about 40%, about 20% to about 45%, about 20% to about 50%, about 20% to about 55%, about 20% to about 60%, about 20% to about 65%, about 20% to about 70%, about 20% to about 80%, about 20% to about 90%, about 30% to about 40%, about 30% to about 45%, about 30% to about 50%, about 30% to about 55%, about 30% to about 60%, about 30% to about 65%, about 30% to about 70%, about 30% to about 80%, about 30% to about 90%, about 40% to about 45%, about 40% to about 50%, about 40% to about 55%, about 40% to about 60%, about 40% to about 65%, about 40% to about 70%, about 40% to about 80%, about 40% to about 90%, about 45% to about 50%, about 45% to about 55%, about 45% to about 60%, about 45% to about 65%, about 45% to about 70%, about 45% to about 80%, about 45% to about 90%, about 50% to about 55%, about 50% to about 60%, about 50% to about 65%, about 50% to about 70%, about 50% to about 80%, about 50% to about 90%, about 55% to about 60%, about 55% to about 65%, about 55% to about 70%, about 55% to about 80%, about 55% to about 90%, about 60% to about 65%, about 60% to about 70%, about 60% to about 80%, about 60% to about 90%, about 65% to about 70%, about 65% to about 80%, about 65% to about 90%, about 70% to about 80%, about 70% to about 90%, or about 80% to about 90%. In some embodiments, the percent of the imaged tissue covered by patch regions is about 10%, about 20%, about 30%, about 40%, about 45%, about 50%, about 55%, about 60%, about 65%, about 70%, about 80%, or about 90%, including increments therein. In some embodiments, the percent of the imaged tissue covered by patch regions is at least about 10%, about 20%, about 30%, about 40%, about 45%, about 50%, about 55%, about 60%, about 65%, about 70%, or about 80%, including increments therein.

In some embodiments, patch regions are square. In some embodiments, each patch region comprises 512×512 pixels at a highest resolution. In some embodiments, patch regions are rectangular, circular, triangular, hexagonal, octagonal, or any suitable shape. In some embodiments, patch regions are formed using computer vision techniques. In some embodiments, patch regions are formed using an edge detection algorithm.

In some embodiments, each patch region comprises about 0.01 megapixels (MP) to about 10 MP. In some embodiments, each patch region comprises about 0.01 MP to about 10 MP. In some embodiments, each patch region comprises about 0.01 MP to about 0.1 MP, about 0.01 MP to about 0.3 MP, about 0.01 MP to about 0.5 MP, about 0.01 MP to about 0.7 MP, about 0.01 MP to about 1 MP, about 0.01 MP to about 3 MP, about 0.01 MP to about 5 MP, about 0.01 MP to about 10 MP, about 0.1 MP to about 0.3 MP, about 0.1 MP to about 0.5 MP, about 0.1 MP to about 0.7 MP, about 0.1 MP to about 1 MP, about 0.1 MP to about 3 MP, about 0.1 MP to about 5 MP, about 0.1 MP to about 10 MP, about 0.3 MP to about 0.5 MP, about 0.3 MP to about 0.7 MP, about 0.3 MP to about 1 MP, about 0.3 MP to about 3 MP, about 0.3 MP to about 5 MP, about 0.3 MP to about 10 MP, about 0.5 MP to about 0.7 MP, about 0.5 MP to about 1 MP, about 0.5 MP to about 3 MP, about 0.5 MP to about 5 MP, about 0.5 MP to about 10 MP, about 0.7 MP to about 1 MP, about 0.7 MP to about 3 MP, about 0.7 MP to about 5 MP, about 0.7 MP to about 10 MP, about 1 MP to about 3 MP, about 1 MP to about 5 MP, about 1 MP to about 10 MP, about 3 MP to about 5 MP, about 3 MP to about 10 MP, or about 5 MP to about 10 MP. In some embodiments, each patch region comprises about 0.01 MP, about 0.1 MP, about 0.3 MP, about 0.5 MP, about 0.7 MP, about 1 MP, about 3 MP, about 5 MP, or about 10 MP. In some embodiments, each patch region comprises at least about 0.01 MP, about 0.1 MP, about 0.3 MP, about 0.5 MP, about 0.7 MP, about 1 MP, about 3 MP, or about 5 MP. In some embodiments, each patch region comprises at most about 0.1 MP, about 0.3 MP, about 0.5 MP, about 0.7 MP, about 1 MP, about 3 MP, about 5 MP, or about 10 MP, including increments therein. In some embodiments, a digital image of a tissue sample is captured at a resolution of about 1 megapixel per square centimeter (MP/cm²), 10 MP/cm², 50 MP/cm², 100 MP/cm², or 1000 MP/cm², including increments therein.

In some embodiments, sample image patches are formed uniformly across the tissue. In some embodiments, spacing between adjacent patches is uniform across the tissue. In some embodiments, a computing system utilizes computer vison techniques to identify regions comprising tissue samples in the histology slide. In some embodiments, image patches are only formed on regions of the slide containing tissue. In some embodiments, histology slides are failed when the number of formed image patches is less than 10, 20, 30, 40, 50, 60, or 70, including increments therein. In slides having less than the required number of patches, a percentile measurement may be unreliable. In slides having less than the required number of patches, it may be likely that the tissue masking had problems. In some embodiments, a technician reviews any slides having less than the required number of patches.

In some embodiments, each image patch is analyzed and given a blur score. In some embodiments, the blur score is directly obtained from a neural network classifier applied to each patch. In some embodiments, the neural network is trained on a data set comprising a plurality of patches wherein each patch is labeled as blurry or not blurry. In some embodiments, the model outputs a probability that the patch is blurry as the blur score. The aggregate of the blur scores for all of the image patch regions is utilized to determine if a slide should be failed for being for having an unacceptable overall level of blurriness. In some embodiments, slide score is determined as the 95th percentile of scores, such that 5% of the tissue in sample has a score equal to the slide score or worse.

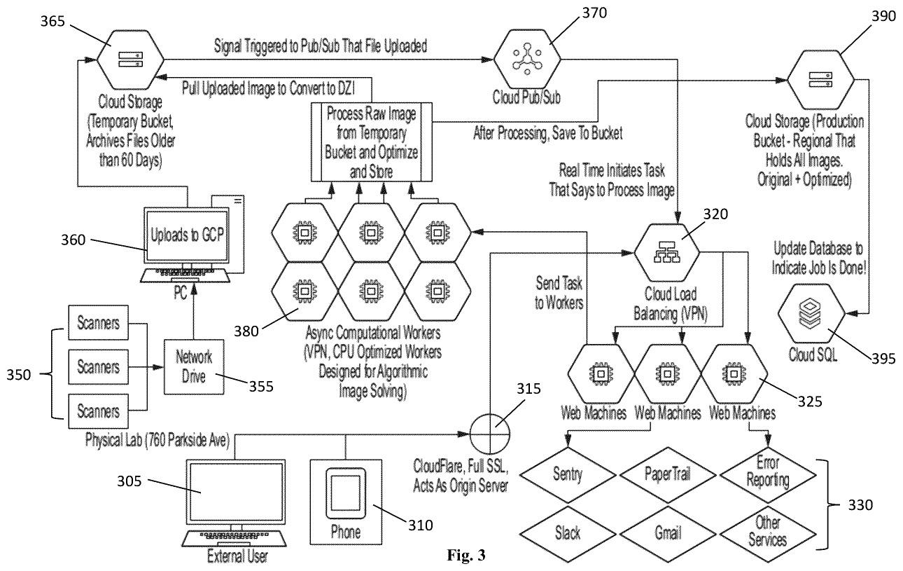

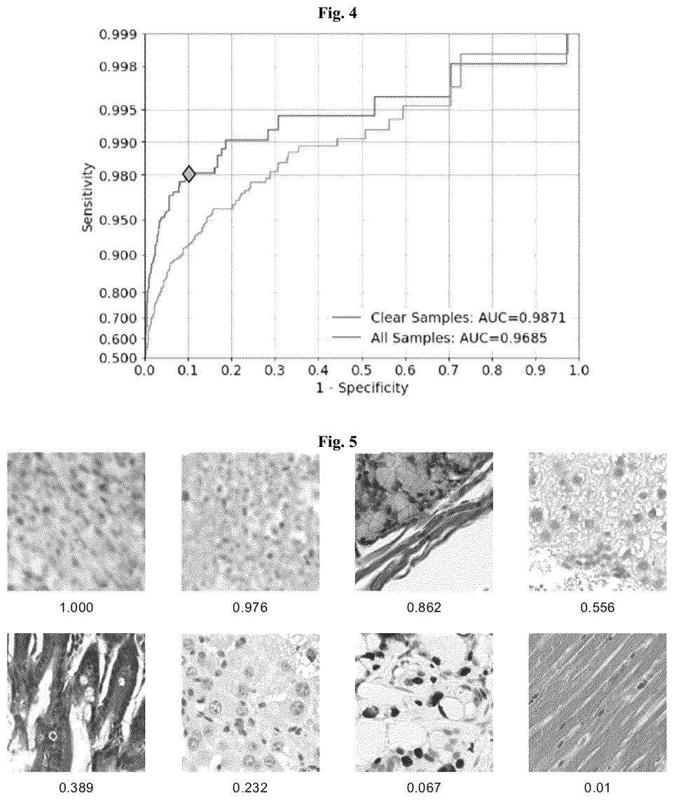

As depicted in FIG. 4, the blur model image analysis algorithm detects 98% of all bad patches while at the same time correctly identifying 70-90% of the good patches. In some embodiments, a clear sample set, as depicted in FIG. 4 excludes ambiguous samples that were difficult to judge. A fail may be considered a positive attribute in this analysis

FIG. 4 depicts an analysis which considers the sensitivity and specificity of the image of a histology slide. In some embodiments, the sensitivity represents the proportion of failed slides correctly identified as fails by the blur model. In some embodiments, the specificity represents the proportion of passed slides which have been confirmed as correctly identified as a pass by the model. If the specificity is lowered, the potential for false positives increases. Use of a lower specificity may increase the number of slides which are needed to be reviewed after analysis by the blur model.

FIG. 5 depicts a plurality of high resolution image patches, each with a blur score assigned by the high resolution quality control model. In some embodiments, a high resolution image patch having a high blur score represents a patch which has been determined to be blurry.

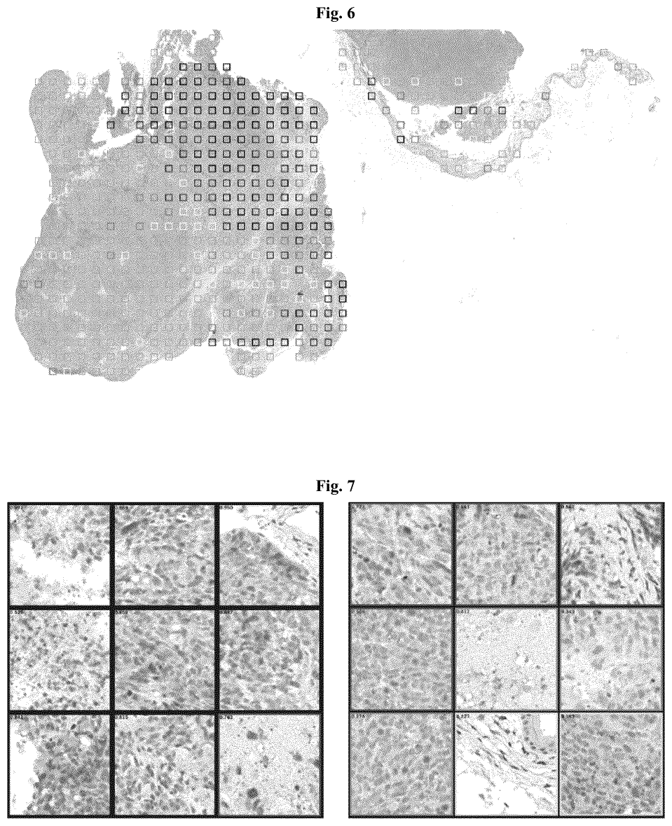

In some embodiments, with reference to FIGS. 6-9, analyzed image patches are each assigned a blur score by the blur model. In some embodiments, an aggregate blur score is utilized to determine if a slide will fail or pass due to the level of blurriness present throughout the slide. In some embodiments, outlines of the patches are super imposed onto the tissue sample image to provide a visual representation of the blurriness of regions across the tissue sample.

I. Super Imposing Patch Regions onto a Tissue Sample Image

In some embodiments, outlines of the image regions are color-coded to represent their assigned blurriness score. In some embodiments, a green outline represents an image region having a low blur score. In some embodiments, a green outline represents an image region which confidently passes the blur model analysis. In some embodiments, a red outline represents an image region having a high blur score. In some embodiments, a red outline represents an image region which confidently fails the blur model analysis. In some embodiments, a yellow outline represents an image region having a medium blur score. In some embodiments, a yellow outline represents an image region which somewhere between passing and failing, but too close to make a confident determination. In some embodiments, an orange outline represents an image region having a medium-high blur score. In some embodiments, an orange outline represents an image region which likely represents a blur failure case, but may be too close to make a confident determination. In some embodiments, a black outline represents an image region having a high blur score. In some embodiments, a black outline represents an image region which confidently fails the blur model analysis. FIG. 15 depicts a comparison between an image patch (left) which confidently passes the blur model analysis and an image patch (right) which confidently fails the blur model analysis. In some embodiments, the image patch (left) confidently passing the blur model analysis would be assigned a green outline, while the image patch (right) would be assigned a black outline.

FIG. 6 depicts an image of a tissue sample with patch regions super imposed onto the tissue sample image. Images of tissue samples with super imposed patch regions may be utilized by a technician to facilitate analysis of the tissue samples. For example, a technician may quickly view patch regions having a high blur score to verify and/or validate the assessment made by the blur model computational analysis.

C. Technician Review

In some embodiments, the method of analyzing digital images of a histology slide for gross errors and blurriness is fully automated. In some embodiments, a technician reviews the digital images of the histology slides at one or more stages during the processing of the slides.

1. Processing without Automation

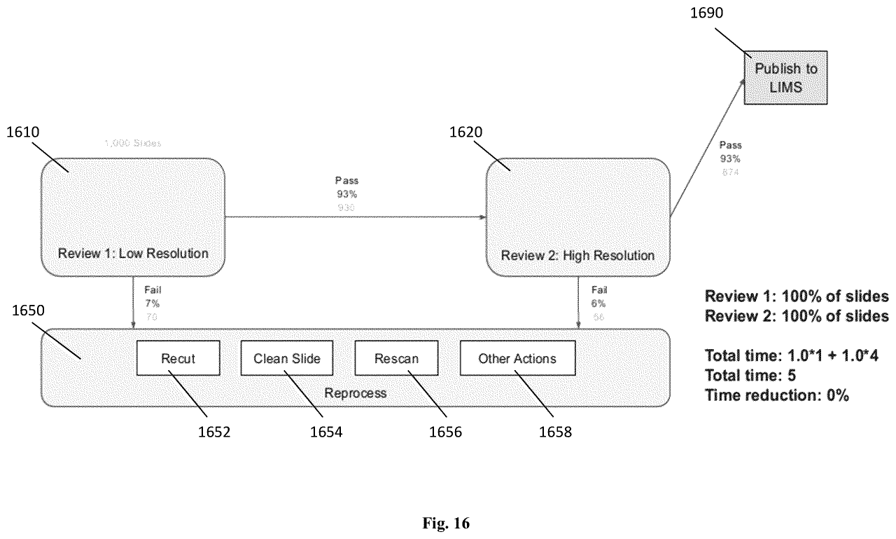

With reference to FIG. 16, a workflow for analyzing slides completed by a technician is depicted, according to some embodiments. At step 1610, a first-stage review may be completed. In some embodiments, the first stage review is conducted at a low zoom level and/or low resolution. In some embodiments, the first stage review analysis gross errors in the digital images of the slides.

In some embodiments, if a digital image of a slide passes the first stage review then the technician will perform a second stage of review, at step 1620. In some embodiments, during the second stage review 1620, the technician analyzes the slides at a high zoom level and/or high resolution. In some embodiments, during the second stage review 1620 the technician analyzes the blurriness of the slide. In some embodiments, slides which pass the second stage review are then uploaded and published to the laboratory information management system at step 1690.

In some embodiments, if a digital image of a slide fails either the first stage review 1610 or the second stage review 1620, then the histology slide from which the image was taken is reprocessed at step 1650. In some embodiments, reprocessing includes re-cutting the sample 1652, cleaning the slide 1654, rescanning the slide 1656, and/or other reprocessing actions such as cleaning the scanner, repositioning the slide cover, etc.

2. Computer Analysis and Technician Review of all Slides

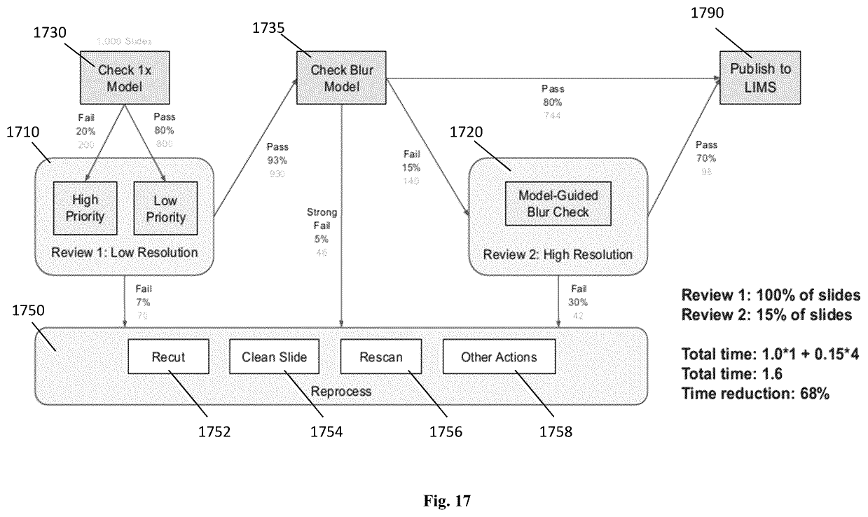

With reference to FIG. 17, a workflow for analyzing slides completed by a technician and an automated system is depicted, according to some embodiments. In some embodiments, at step 1730, an automated low zoom review is completed using the computer systems described herein. In some embodiments, the low zoom review model 1730 analyzes slides for gross errors in the histology slides or digital image of the histology slides.

In some embodiments, all slides are then reviewed by a technician at step 1710. In some embodiments, the first review by the technician 1710 is also completed at a lower resolution. In some embodiments, during the first technician review 1710 the technician reviews the slide images for gross errors. In some embodiments, slides which are failed by the automated analysis are marked with a high priority for review by the technician. In some embodiments, slides which are passed by the automated analysis are marked with a low priority for review by the technician. In some embodiments, if the technician determines that a slide fails, then the slide is reprocessed at step 1750. In some embodiments, reprocessing includes re-cutting the sample 1752, cleaning the slide 1754, rescanning the slide 1756, and/or other reprocessing actions such as cleaning the scanner, repositioning the slide cover, etc.

In some embodiments, at step 1735, slide images which pass the technician review are then sent to the blur model analysis, at step 1735, as described herein. In some embodiments, the blur model determines if a slide image strongly fails the blurriness analysis it is sent to be reprocessed at step 1750. In some embodiments, the blur model determines if a slide image strongly fails the blurriness analysis it is then reviewed by a technician at step 1720. In some embodiments, if the blur model determines the slide is acceptable, then the slide is uploaded and published to the laboratory information management system at step 1790.

In some embodiments, at step 1720, a technician review slide images which have failed the automated blur model analysis. In some embodiments, the technician blur review 1720 is model guided, as disclosed herein. In some embodiments, if the technician determines the slide image fails the blur check, the slide is sent to be reprocessed at step 1750. In some embodiments, if the technician determines the slide image fails the blur check, the slide image is uploaded and published to the laboratory information management system at step 1790.

3. Computer Analysis and Technician Review of Some Slides

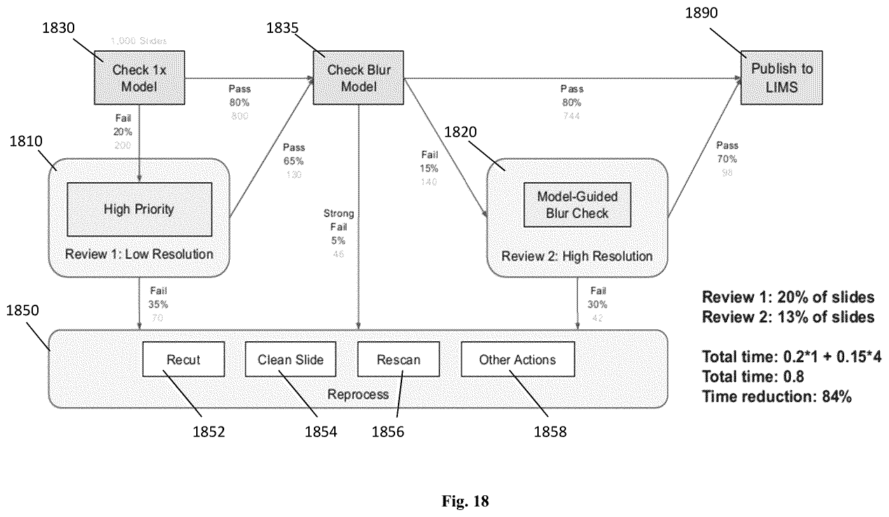

With reference to FIG. 18, a workflow for analyzing slides completed by an automated system and reviewed by a technician is depicted, according to some embodiments. In some embodiments, at step 1830, an automated low zoom review is completed using the computer systems described herein. In some embodiments, the low zoom review model 1830 analyzes slides for gross errors in the histology slides or digital image of the histology slides.

In some embodiments, only slides which have failed the automated review at step 1830 are reviewed by a technician at step 1810. In some embodiments, the first review by the technician 1810 is also completed at a lower resolution. In some embodiments, during the first technician review 1810 the technician reviews the slide images for gross errors. In some embodiments, slides which are failed by the automated analysis are marked with a high priority for review by the technician. In some embodiments, if the technician determines that a slide fails, then the slide is reprocessed at step 1850. In some embodiments, reprocessing includes re-cutting the sample 1852, cleaning the slide 1854, rescanning the slide 1856, and/or other reprocessing actions such as cleaning the scanner, repositioning the slide cover, etc.

In some embodiments, slides which pass the automated gross error review 1830 or the first review by a technician 1810 are then sent to the automated blur model, at step 1835. In some embodiments, the blur model determines if a slide image strongly fails the blurriness analysis it is sent to be reprocessed at step 1850. In some embodiments, the blur model determines if a slide image strongly fails the blurriness analysis it is then reviewed by a technician at step 1820. In some embodiments, if the blur model determines the slide is acceptable, then the slide is uploaded and published to the laboratory information management system at step 1890.

In some embodiments, at step 1820, a technician review slide images which have failed the automated blur model analysis. In some embodiments, the technician blur review 1820 is model guided, as disclosed herein. In some embodiments, if the technician determines the slide image fails the blur check, the slide is sent to be reprocessed at step 1850. In some embodiments, if the technician determines the slide image fails the blur check, the slide image is uploaded and published to the laboratory information management system at step 1890.

In some embodiments, a method utilizing a technician to review only slides which fail the automated analyses is very efficient. In some embodiments, such a method allows for an 84% time reduction in the analysis of slide images, when compared to an analysis only performed by a technician, while still being accurate.

4. Model-Guided Blur Review

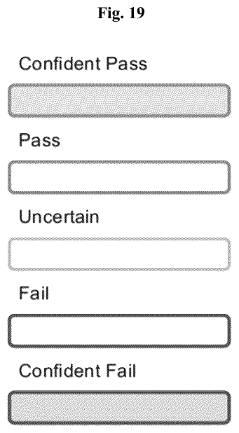

In some embodiments, the automated slide analysis systems herein provide a guided review for a technician. In some embodiments, the guided review is provided as a graphical user interface. According to some embodiments, FIG. 19 depicts a key for the graphical user interface, wherein a shaded green box denotes a confident pass, a green outline denotes a pass, a yellow box denotes an uncertain analysis, a red box denotes a fail, and a shaded red box denotes a confident fail as analyzed by the automated systems.

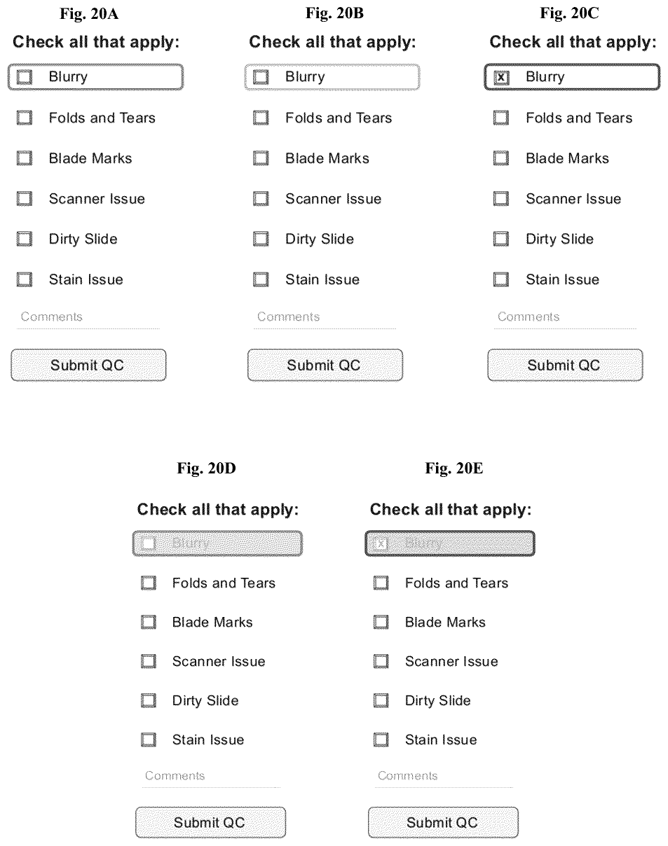

FIGS. 20A-20E depict a graphical user interface for provided for a technician review after completion of a computer implemented slide analysis. In some embodiments, the graphical user interface comprises one or more check boxes which are selectable to indicate errors or issues with a digital image of a histology slide. In some embodiments, the category selectable to indicate a blurry slide is highlighted to indicate the results of the blur model analysis. In some embodiments, a selectable box to indicate a blurry slide is pre-selected to indicate a slide which fails or confidently fails the blur model analysis. In some embodiments, a slide which confidently fails the blur model analysis will not allow a technician to unselect the box indicating that the slide is blurry, as depicted in FIG. 20E. In some embodiments, a slide which confidently passes the blur model analysis will not allow a technician to select the box indicating that the slide is blurry, as depicted in FIG. 20D.

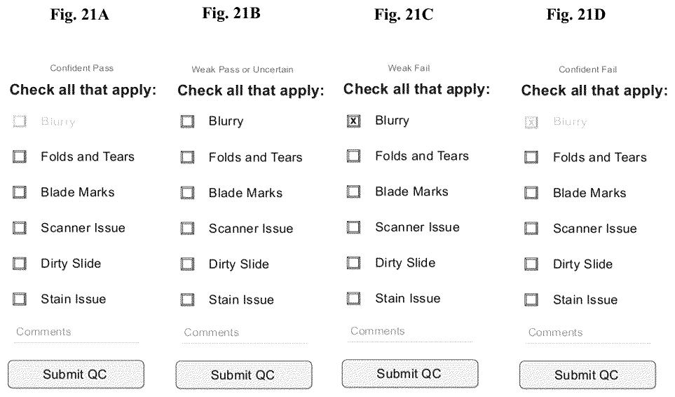

FIGS. 21A-21D depict a graphical user interface for provided for a technician review after completion of a computer implemented slide analysis. In some embodiments, the graphical user interface is provided in grey scale or without color. In some embodiments, the results from the blur model analysis are provided above the selectable boxes. In some embodiments, a slide which confidently fails the blur model analysis will not allow a technician to unselect the box indicating that the slide is blurry, as depicted in FIG. 21D. In some embodiments, a slide which confidently passes the blur model analysis will not allow a technician to select the box indicating that the slide is blurry, as depicted in FIG. 21A.

### IV. DEFINITIONS

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used in the specification and claims, the singular forms “a,” “an,” and “the” include plural references unless the context clearly dictates otherwise. For example, the term “a sample” includes a plurality of samples, including mixtures thereof.

The terms “determining,” “measuring,” “evaluating,” “assessing,” “assaying,” and “analyzing” are often used interchangeably herein to refer to forms of measurement. The terms include determining if an element is present or not (for example, detection). These terms can include quantitative, qualitative or quantitative and qualitative determinations. Assessing can be relative or absolute. “Detecting the presence of” can include determining the amount of something present in addition to determining whether it is present or absent depending on the context.

The terms “subject,” “individual,” or “patient” are often used interchangeably herein. A “subject” can be a biological entity containing expressed genetic materials. The biological entity can be a plant, animal, or microorganism, including, for example, bacteria, viruses, fungi, and protozoa. The subject can be tissues, cells and their progeny of a biological entity obtained in vivo or cultured in vitro. The subject can be a mammal. The mammal can be a human. The subject may be diagnosed or suspected of being at high risk for a disease. In some cases, the subject is not necessarily diagnosed or suspected of being at high risk for the disease.

The term “in vivo” is used to describe an event that takes place in a subject's body.

The term “ex vivo” is used to describe an event that takes place outside of a subject's body. An ex vivo assay is not performed on a subject. Rather, it is performed upon a sample separate from a subject. An example of an ex vivo assay performed on a sample is an “in vitro” assay.

The term “in vitro” is used to describe an event that takes places contained in a container for holding laboratory reagent such that it is separated from the biological source from which the material is obtained. In vitro assays can encompass cell-based assays in which living or dead cells are employed. In vitro assays can also encompass a cell-free assay in which no intact cells are employed.

As used herein, the term “about” a number refers to that number plus or minus 10% of that number. The term “about” a range refers to that range minus 10% of its lowest value and plus 10% of its greatest value.

As used herein, the terms “treatment” or “treating” are used in reference to a pharmaceutical or other intervention regimen for obtaining beneficial or desired results in the recipient. Beneficial or desired results include but are not limited to a therapeutic benefit and/or a prophylactic benefit. A therapeutic benefit may refer to eradication or amelioration of symptoms or of an underlying disorder being treated. Also, a therapeutic benefit can be achieved with the eradication or amelioration of one or more of the physiological symptoms associated with the underlying disorder such that an improvement is observed in the subject, notwithstanding that the subject may still be afflicted with the underlying disorder. A prophylactic effect includes delaying, preventing, or eliminating the appearance of a disease or condition, delaying or eliminating the onset of symptoms of a disease or condition, slowing, halting, or reversing the progression of a disease or condition, or any combination thereof. For prophylactic benefit, a subject at risk of developing a particular disease, or to a subject reporting one or more of the physiological symptoms of a disease may undergo treatment, even though a diagnosis of this disease may not have been made.

The section headings used herein are for organizational purposes only and are not to be construed as limiting the subject matter described.

### Computing System

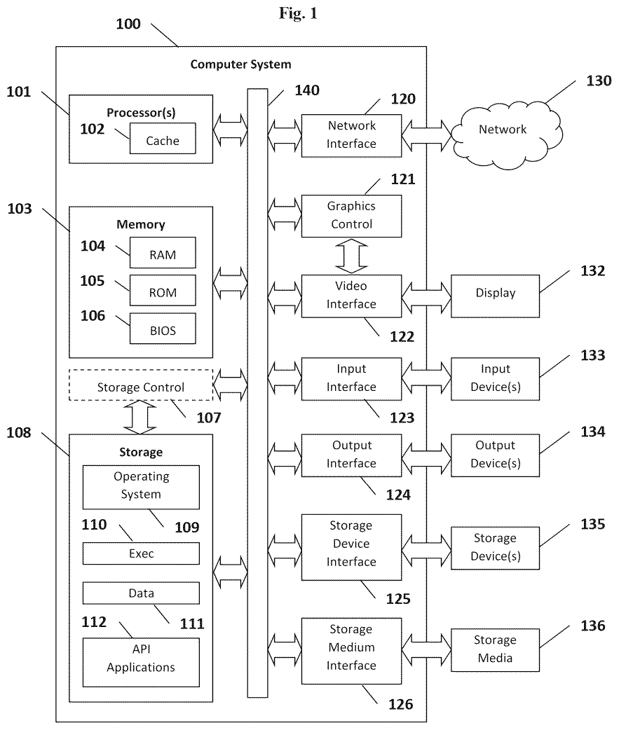

Referring to FIG. 1, a block diagram is shown depicting an exemplary machine that includes a computer system 100 (e.g., a processing or computing system) within which a set of instructions can execute for causing a device to perform or execute any one or more of the aspects and/or methodologies for static code scheduling of the present disclosure. The components in FIG. 1 are examples only and do not limit the scope of use or functionality of any hardware, software, embedded logic component, or a combination of two or more such components implementing particular embodiments.

Computer system 100 may include one or more processors 101, a memory 103, and a storage 108 that communicate with each other, and with other components, via a bus 140. The bus 140 may also link a display 132, one or more input devices 133 (which may, for example, include a keypad, a keyboard, a mouse, a stylus, etc.), one or more output devices 134, one or more storage devices 135, and various tangible storage media 136. All of these elements may interface directly or via one or more interfaces or adaptors to the bus 140. For instance, the various tangible storage media 136 can interface with the bus 140 via storage medium interface 126. Computer system 100 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 100 includes one or more processor(s) 101 (e.g., central processing units (CPUs), general purpose graphics processing units (GPGPUs), or quantum processing units (QPUs)) that carry out functions. Processor(s) 101 optionally contains a cache memory unit 102 for temporary local storage of instructions, data, or computer addresses. Processor(s) 101 are configured to assist in execution of computer readable instructions. Computer system 100 may provide functionality for the components depicted in FIG. 1 as a result of the processor(s) 101 executing non-transitory, processor-executable instructions embodied in one or more tangible computer-readable storage media, such as memory 103, storage 108, storage devices 135, and/or storage medium 136. The computer-readable media may store software that implements particular embodiments, and processor(s) 101 may execute the software. Memory 103 may read the software from one or more other computer-readable media (such as mass storage device(s) 135, 136) or from one or more other sources through a suitable interface, such as network interface 120. The software may cause processor(s) 101 to carry out one or more processes or one or more steps of one or more processes described or illustrated herein. Carrying out such processes or steps may include defining data structures stored in memory 103 and modifying the data structures as directed by the software.

The memory 103 may include various components (e.g., machine readable media) including, but not limited to, a random access memory component (e.g., RAM 104) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 105 may act to communicate data and instructions unidirectionally to processor(s) 101, and RAM 104 may act to communicate data and instructions bidirectionally with processor(s) 101. ROM 105 and RAM 104 may include any suitable tangible computer-readable media described below. In one example, a basic input/output system 106 (BIOS), including basic routines that help to transfer information between elements within computer system 100, such as during start-up, may be stored in the memory 103.

Fixed storage 108 is connected bidirectionally to processor(s) 101, optionally through storage control unit 107. Fixed storage 108 provides additional data storage capacity and may also include any suitable tangible computer-readable media described herein. Storage 108 may be used to store operating system 109, executable(s) 110, data 111, applications 112 (application programs), and the like. Storage 108 can also include an optical disk drive, a solid-state memory device (e.g., flash-based systems), or a combination of any of the above. Information in storage 108 may, in appropriate cases, be incorporated as virtual memory in memory 103.

In one example, storage device(s) 135 may be removably interfaced with computer system 100 (e.g., via an external port connector (not shown)) via a storage device interface 125. Particularly, storage device(s) 135 and an associated machine-readable medium may provide non-volatile and/or volatile storage of machine-readable instructions, data structures, program modules, and/or other data for the computer system 100. In one example, software may reside, completely or partially, within a machine-readable medium on storage device(s) 135. In another example, software may reside, completely or partially, within processor(s) 101.

Bus 140 connects a wide variety of subsystems. Herein, reference to a bus may encompass one or more digital signal lines serving a common function, where appropriate. Bus 140 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 100 may also include an input device 133. In one example, a user of computer system 100 may enter commands and/or other information into computer system 100 via input device(s) 133. Examples of an input device(s) 133 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 133 may be interfaced to bus 140 via any of a variety of input interfaces 123 (e.g., input interface 123) including, but not limited to, serial, parallel, game port, USB, FIREWIRE, THUNDERBOLT, or any combination of the above.

In particular embodiments, when computer system 100 is connected to network 130, computer system 100 may communicate with other devices, specifically mobile devices and enterprise systems, distributed computing systems, cloud storage systems, cloud computing systems, and the like, connected to network 130. Communications to and from computer system 100 may be sent through network interface 120. For example, network interface 120 may receive incoming communications (such as requests or responses from other devices) in the form of one or more packets (such as Internet Protocol (IP) packets) from network 130, and computer system 100 may store the incoming communications in memory 103 for processing. Computer system 100 may similarly store outgoing communications (such as requests or responses to other devices) in the form of one or more packets in memory 103 and communicated to network 130 from network interface 120. Processor(s) 101 may access these communication packets stored in memory 103 for processing.

Examples of the network interface 120 include, but are not limited to, a network interface card, a modem, and any combination thereof. Examples of a network 130 or network segment 130 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 130, may employ a wired and/or a wireless mode of communication. In general, any network topology may be used.

Information and data can be displayed through a display 132. Examples of a display 132 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 132 can interface to the processor(s) 101, memory 103, and fixed storage 108, as well as other devices, such as input device(s) 133, via the bus 140. The display 132 is linked to the bus 140 via a video interface 122, and transport of data between the display 132 and the bus 140 can be controlled via the graphics control 121. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 132, computer system 100 may include one or more other peripheral output devices 134 including, but not limited to, an audio speaker, a printer, a storage device, and any combinations thereof. Such peripheral output devices may be connected to the bus 140 via an output interface 124. Examples of an output interface 124 include, but are not limited to, a serial port, a parallel connection, a USB port, a FIREWIRE port, a THUNDERBOLT port, and any combinations thereof.

In addition or as an alternative, computer system 100 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, cloud computing platforms, distributed computing systems, server computers, desktop computers, laptop computers, notebook computers, sub-notebook computers, netbook computers, computers, set-top computers, media streaming devices, handheld computers, Internet appliances, mobile smartphones, tablet computers, and personal digital assistants.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux, and Palm® WebOS®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database or datastore systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C #, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and PhoneGap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. The terms database and datastore may be used interchangeably herein. In view of the disclosure provided herein, those of skill in the art will recognize that many databases are suitable for storage and retrieval of digital images of histology slides, results of a computational analysis, results of a blur model analysis, results of a gross error analysis, subject information, sample information, and system information. In various embodiments, suitable databases include, by way of non-limiting examples, relational databases, non-relational databases, object oriented databases, object databases, entity-relationship model databases, associative databases, XML databases, and document oriented databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### V. EXAMPLES

The following examples are included for illustrative purposes only and are not intended to limit the scope of the present subject matter.

### Example 1: False Negative Example

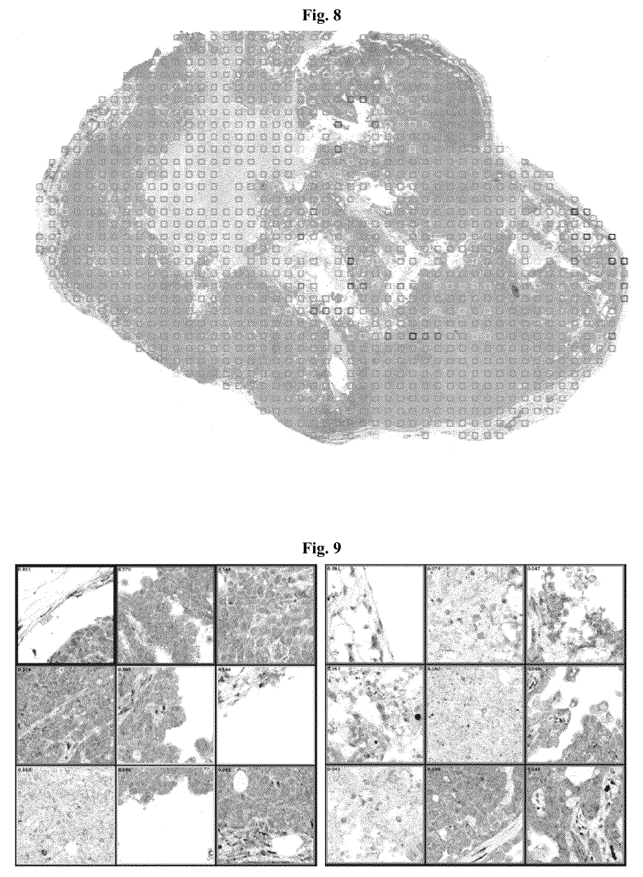

FIGS. 8 and 9 depict an example of an analysis performed on a digital image of a histology slide, according to some embodiments. In the example, the slide has been analyzed by the blur model, as disclosed herein, which utilizes image patch regions to assess an aggregate blurriness. In the example, the slide contains a few regions which are slightly blurry. The blur analysis model passes the slide, while the ground truth fails it. In some embodiments, the blur analysis model provides a slide score of 0.34 for this slide. In some embodiments, the slide analysis provides an example of a false negative, wherein the slide fails but it would not be an egregious mistake to pass the slide.

### Example 2: False Positive Examples

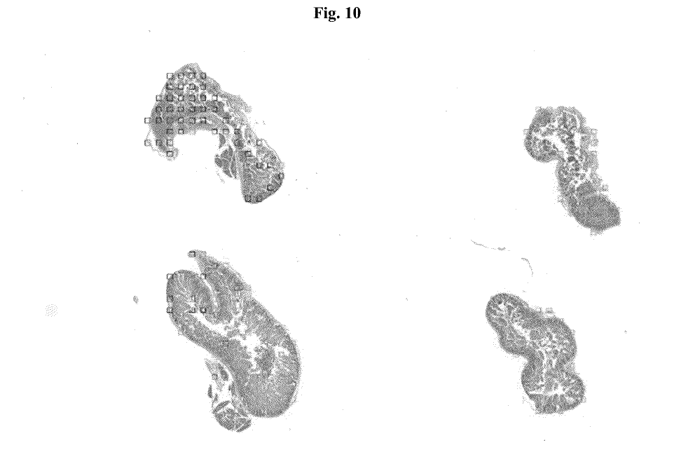

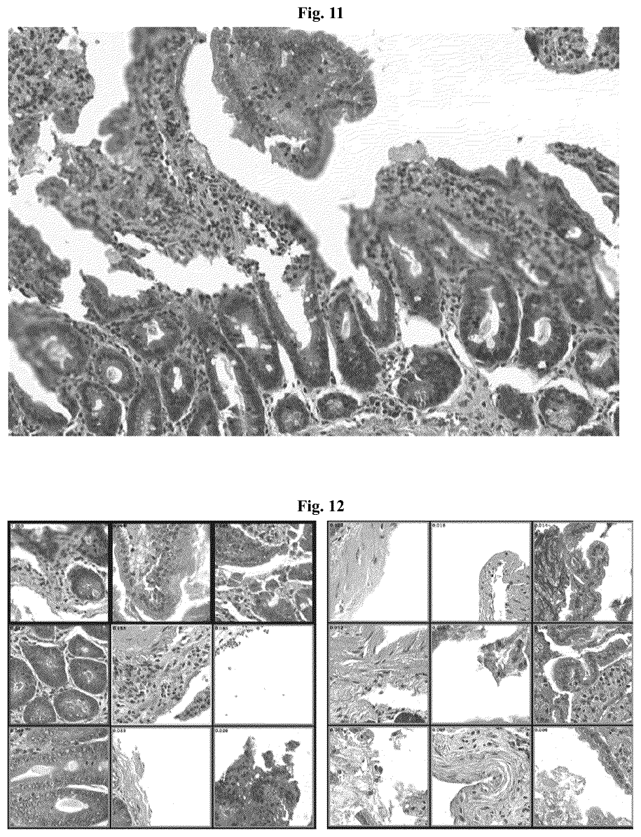

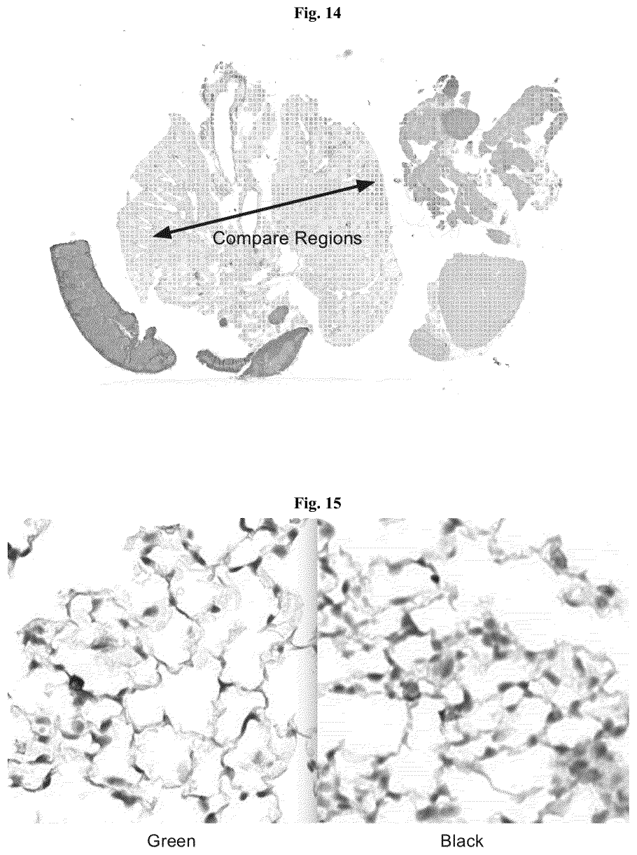

FIGS. 10-15 depict examples of analyses performed on digital images of histology slides. In the examples, the slides have been analyzed by the blur model, as disclosed herein, which utilizes image patch regions to assess an aggregate blurriness.

In the example depicted by FIGS. 10-12, the slide contains many small samples. Most image regions of the slide are clear, but some regions are significantly blurry. While the ground truth passes this slide, the blur analysis model assigns it a slide score of 0.95. Accordingly, the slide should be failed, and therefore this example represents a false positive.

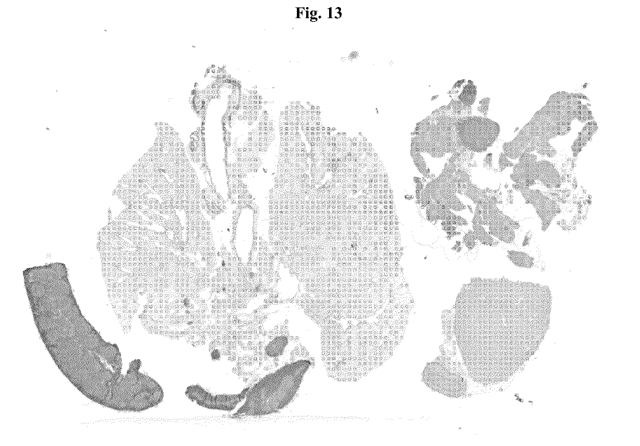

In the example depicted by FIGS. 13-15, the slide provides an image of a tissue sample having a few distinct regions. In some embodiments, the blur analysis model compares image patch regions across portions of the slide. Most regions of the slide are ok, but the blur analysis model properly identifies regions that are somewhat blurry. In the example, the ground truth passes the slide, while the blur analysis model assigns it a slide score of 0.90. Accordingly, this presents an example of a seemingly false positive slide wherein a review by a technician should be performed to make a final decisions as to whether the slide should be passed or failed.

While preferred embodiments of the present subject matter have been shown and described herein, it will be obvious to those skilled in the art that such embodiments are provided by way of example only. Numerous variations, changes, and substitutions will now occur to those skilled in the art without departing from the subject matter described herein. It should be understood that various alternatives to the embodiments of the subject matter described herein may be employed in practice. It is intended that the following claims define the scope of the present subject matter and that methods and structures within the scope of these claims and their equivalents be covered thereby.

What is claimed is:

1. A method of performing quality control comprising:
a) receiving a digital micrograph representing a slide with a tissue sample;
b) performing a first-stage quality review of the digital micrograph at a first magnification, the first-stage quality review comprising: applying a plurality of first machine learning models, each first machine learning model trained to identify a particular quality failure case;
c) performing a second-stage quality review of the digital micrograph at a second magnification, the second-stage quality review comprising:
i. identifying a plurality of patches covering the tissue sample;
ii. applying a second machine learning model to each patch to identify a blur failure case for the patch; and
iii. determining a blur failure case for the digital micrograph based on blur failure cases identified for the patches; and
d) generating a quality control report for the digital micrograph.

2. The method of claim 1, wherein the digital micrograph is a zoomable image comprising at least 30,000, at least 40,000, or at least 50,000 static digital images.

3. The method of claim 1, wherein the digital micrograph is a light micrograph.

4. The method of claim 3, wherein the light micrograph is a bright field micrograph.

5. The method of claim 3, wherein the light micrograph is a fluorescence micrograph.

6. The method of claim 1, wherein the tissue sample is a human tissue sample.

7. The method of claim 1, wherein the tissue sample is a veterinary tissue sample.

8. The method of claim 1, wherein at least one of the quality failure cases is selected from the group consisting of: tissue fold, tissue tear, tissue separation, tissue crack, inadequate stain, incorrect stain, missing stain, cover slip issue, missing coverslip, dirty coverslip, air bubble, dirty slide, floater, blade mark, microvibration, cutting issue, blurry content, scanner artifact, not enough tissue, incorrect tissue, and combinations thereof.

9. The method of claim 1, wherein the second magnification is higher than the first magnification.

10. The method of claim 1, wherein the first magnification is about 1× to about 4× or a corresponding digital image resolution of about 10 micrometers (microns) per pixel (mpp) to about 2.5 mpp.

11. The method of claim 1, wherein the second magnification is about 20× to about 100× or a corresponding digital image resolution of about 0.5 mpp to about 0.1 mpp.

12. The method of claim 1, wherein at least one of the first machine learning models comprises one or more neural networks.

13. The method of claim 12, wherein the one or more neural networks comprises one or more deep convolutional neural networks.

14. The method of claim 1, wherein the plurality of first machine learning models are only applied to regions of the slide identified as containing tissue.

15. The method of claim 1, wherein the plurality of patches comprises at least 30, at least 40, or at least 50 patches.

16. The method of claim 1, wherein the plurality of patches covers at least 30%, at least 40%, or at least 50% of the tissue sample.

17. The method of claim 1, wherein each patch is about 512 pixels by 512 pixels.

18. The method of claim 1, wherein the second machine learning model comprises one or more neural networks.

19. The method of claim 18, wherein the one or more neural networks comprises one or more deep convolutional neural networks.

20. The method of claim 1, wherein determining a blur failure case for the digital micrograph comprises calculating statistics across blur failure cases identified for the patches or a blur probability score assigned to each patch.

21. The method of claim 1, wherein determining a blur failure case for the digital micrograph comprises calculating a 95th percentile of blur failure cases identified for the patches.

22. The method of claim 1, further comprising training each first machine learning model to identify a particular quality failure case utilizing an annotated training data set.

23. The method of claim 1, further comprising training the second machine learning model to identify a blur failure case utilizing an annotated training data set.

24. The method of claim 1, further comprising validating a sensitivity and a specificity of each first machine learning model in identifying a quality failure case.

25. The method of claim 1, further comprising validating a sensitivity and a specificity of the second machine learning model in identifying a blur failure case.

26. The method of claim 1, further comprising processing the tissue sample and preparing the slide.

27. The method of claim 1, further comprising performing a human macroscopic review of the slide and the tissue sample prior to generating the digital micrograph.

28. The method of claim 1, further comprising scanning and digitizing the slide to generate the digital micrograph.

29. The method of claim 1, wherein the quality control report comprises one or more quality scores.

30. The method of claim 1, wherein the quality control report comprises one or more quality recommendations.

31. The method of claim 1, wherein the quality control report comprises one or more corrective recommendations.

32. The method of claim 1, wherein the quality control report comprises one or more visual presentations of problematic slide regions.

33. The method of claim 1, wherein the quality control report is integrated with the digital micrograph as metadata.

34. The method of claim 33, further comprising storing the digital micrograph in an archival system.

35. The method of claim 1, wherein the steps are automated and performed by a computing platform.

36. The method of claim 1, further comprising performing a human review of all or a subset of results of the first-stage quality review.

37. The method of claim 1, further comprising performing a human review of all or a subset of results of the second-stage quality review.

38. The method of claim 1, wherein, if at the first-stage quality review, one or more of the first machine learning models identifies a quality failure case, the digital micrograph is rejected and the second-stage quality review is not performed.

39. The method of claim 1, further comprising providing a viewer application configured to view the digital micrograph, wherein the view application displays one or more aspects of the quality control report in association with the digital micrograph.

40. The method of claim 1, wherein the first-stage quality review, for each first machine learning model, comprises:
a) identifying a plurality of patches covering the tissue sample, the slide, or both;
b) applying the first machine learning model to each patch to identify a failure case for the patch; and
c) determining a failure case for the digital micrograph based on failure cases identified for the patches.

41. A system comprising: at least one processor, a memory, and instructions executable by the at least one processor to create a quality control application comprising:
a) a software module receiving a digital micrograph representing a slide with a tissue sample;
b) a software module performing a first-stage quality review of the digital micrograph at a first magnification, the first-stage quality review comprising: applying a plurality of first machine learning models, each first machine learning model trained to identify a particular quality failure case;
c) a software module performing a second-stage quality review of the digital micrograph at a second magnification, the second-stage quality review comprising: identifying a plurality of patches covering the tissue sample;
applying a second machine learning model to each patch to identify a blur failure case for the patch; and determining a blur failure case for the digital micrograph based on blur failure cases identified for the patches; and
d) a software module generating a quality control report for the digital micrograph.

42. A non-transitory computer-readable storage media encoded with a computer program including instructions executable by a processor to create a quality control application comprising:
a) an intake module configured to receive a digital micrograph representing a slide with a tissue sample;
b) a first quality control module configured to perform a first-stage quality review of the digital micrograph at a first magnification, the first-stage quality review comprising: applying a plurality of first machine learning models, each first machine learning model trained to identify a particular quality failure case;
c) a second quality control module configured to perform a second-stage quality review of the digital micrograph at a second magnification, the second-stage quality review comprising: identifying a plurality of patches covering the tissue sample; applying a second machine learning model to each patch to identify a blur failure case for the patch; and determining a blur failure case for the digital micrograph based on blur failure cases identified for the patches; and
d) a report module configured to generate a quality control report for the digital micrograph.

43. A platform comprising a digital scanner and a computing device: the digital scanner communicatively coupled to the computing device; and the computing device comprising at least one processor, a memory, and instructions executable by the at least one processor to create quality control application comprising:
a) a software module receiving, from the digital scanner, a digital micrograph representing a slide with a tissue sample;
b) a software module performing a first-stage quality review of the digital micrograph at a first magnification, the first-stage quality review comprising: applying a plurality of first machine learning models, each first machine learning model trained to identify a particular quality failure case;
c) a software module performing a second-stage quality review of the digital micrograph at a second magnification, the second-stage quality review comprising: identifying a plurality of patches covering the tissue sample;
applying a second machine learning model to each patch to identify a blur failure case for the patch; and determining a blur failure case for the digital micrograph based on blur failure cases identified for the patches; and
d) a software module generating a quality control report for the digital micrograph.

44. A method of performing quality control comprising:
a) receiving a digital micrograph representing a slide with a tissue sample;
b) performing a quality review of the digital micrograph comprising: applying a plurality of machine learning models, each machine learning model trained to identify a particular quality failure case;
wherein applying at least one of the plurality of machine learning models comprises: identifying a plurality of patches covering the tissue sample, the slide, or both; applying the machine learning model to each patch to identify a failure case for the patch; and determining a failure case for the digital micrograph based on failure cases identified for the patches;
wherein at least one of the plurality of machine learning models is applied to the digital micrograph at a first magnification and at least one of the plurality of machine learning models is applied to the digital micrograph at a second magnification; and
c) generating a quality control report for the digital micrograph.

45. The method of claim 44, wherein the digital micrograph is a zoomable image comprising at least 30,000, at least 40,000, or at least 50,000 static digital images.

46. The method of claim 44, wherein the digital micrograph is a light micrograph.

47. The method of claim 46, wherein the light micrograph is a bright field micrograph.

48. The method of claim 46, wherein the light micrograph is a fluorescence micrograph.

49. The method of claim 44, wherein the tissue sample is a human tissue sample.

50. The method of claim 44, wherein the tissue sample is a veterinary tissue sample.

51. The method of claim 44, wherein at least one of the quality failure cases is selected from the group consisting of: blur, tissue fold, tissue tear, tissue separation, tissue crack, inadequate stain, incorrect stain, missing stain, cover slip issue, missing coverslip, dirty coverslip, air bubble, dirty slide, floater, blade mark, microvibration, cutting issue, blurry content, scanner artifact, not enough tissue, incorrect tissue, and combinations thereof.

52. The method of claim 44, wherein the first magnification is about 1× to about 4× or a corresponding digital image resolution of about 10 micrometers (microns) per pixel (mpp) to about 2.5 mpp.

53. The method of claim 44, wherein the second magnification is about 20× to about 100× or a corresponding digital image resolution of about 0.5 mpp to about 0.1 mpp.

54. The method of claim 44, wherein at least one of the machine learning models comprises one or more neural networks.

55. The method of claim 54, wherein the one or more neural networks comprises one or more deep convolutional neural networks.

56. The method of claim 44, wherein the plurality of machine learning models are only applied to regions of the slide identified as containing tissue.

57. The method of claim 44, wherein the plurality of patches comprises at least 30, at least 40, or at least 50 patches.

58. The method of claim 44, wherein the plurality of patches covers at least 30%, at least 40%, or at least 50% of the tissue sample or the slide.

59. The method of claim 44, wherein each patch is about 512 pixels by 512 pixels.

60. The method of claim 44, wherein determining a failure case for the digital micrograph comprises calculating statistics across failure cases identified for the patches or a probability score assigned to each patch.

61. The method of claim 44, wherein determining a failure case for the digital micrograph comprises calculating a 95th percentile of failure cases identified for the patches.

62. The method of claim 44, further comprising training each machine learning model to identify a particular quality failure case utilizing an annotated training data set.

63. The method of claim 44, further comprising validating a sensitivity and a specificity of each machine learning model in identifying a quality failure case.

64. The method of claim 44, further comprising processing the tissue sample and preparing the slide.

65. The method of claim 44, further comprising performing a human macroscopic review of the slide and the tissue sample prior to generating the digital micrograph.

66. The method of claim 44, further comprising scanning and digitizing the slide to generate the digital micrograph.

67. The method of claim 44, wherein the quality control report comprises one or more quality scores.

68. The method of claim 44, wherein the quality control report comprises one or more quality recommendations.

69. The method of claim 44, wherein the quality control report comprises one or more corrective recommendations.

70. The method of claim 44, wherein the quality control report comprises one or more visual presentations of problematic slide regions.

71. The method of claim 44, wherein the quality control report is integrated with the digital micrograph as metadata.

72. The method of claim 71, further comprising storing the digital micrograph in an archival system.

73. The method of claim 44, wherein the steps are automated and performed by a computing platform.

74. The method of claim 44, further comprising performing a human review of all or a subset of results of the quality review.

75. The method of claim 44, further comprising providing a viewer application configured to view the digital micrograph, wherein the view application displays one or more aspects of the quality control report in association with the digital micrograph.
